(19) United States
(12) Patent Application Publication
(10) Pub. No.: US 2018/0294525 A1
(43) Pub. Date: Oct. 11, 2018

(54) NOVEL LITHIUM BORACARBONATE ION PAIR

(71) Applicant: RIKEN, Wako-shi (JP)

(72) Inventors: Liang ZHANG, Wako-shi (JP); Masayoshi NISHIURA, Wako-shi (JP); Zhaomin HOU, Wako-shi (JP)

(21) Appl. No.: 15/947,354

(22) Filed: Apr. 6, 2018

(30) Foreign Application Priority Data
Apr. 7, 2017 (KR) 10-2017-0045206

(51) Int. Cl. H01M 10/0568; H01M 10/0525

(52) U.S. Cl. CPC H01M 10/0568; C07F 1/02; H01M 10/0525

(57) ABSTRACT

The present invention is a method for producing a compound (i), including the step of:
reacting a compound (ii), a compound (iii), and carbon dioxide together in the presence of a copper catalyst and a lithium-based nucleophilic reagent,
the compound (ii) being represented by formula (1):

R3−C(R30)=X (1),
the compound (iii) being represented by formula (2):

(Z1)B−B(Z2) (2), and
the compound (i) being represented by formula (3):

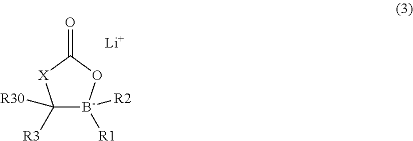

### TECHNICAL FIELD

The present invention relates to a method for producing a lithium boracarbonate ion pair, novel lithium boracarbonate ion pair, and use thereof.

### BACKGROUND ART

The most common form of lithium ion batteries consists of a graphite anode, an organic solvent electrolyte and a metal oxide cathode. The use of lithium borate salts as the electrolyte salt have been arousing intensive interest in the lithium battery field due to their unique properties such as excellent thermal stability, comparable ionic conductivity, cost-effectiveness, environmental benignity and favorable the solid electrolyte interface (SEI) forming properties when compared to the conventional LiFP₆ salt (reference:NPL1-6).

Lithium bis(oxalato) borate (LiBOB) was initially studied as an alternative salt to improve the high temperature performance of Li-ion batteries. It is shown that this salt not only is capable of suppressing solvent irreversible reduction, but also significantly stabilizes SEI against the extended cycling. Further study revealed that LiBOB still retained its strong ability to facilitate SEI formation even its content in the electrolyte was reduced to an additive level.

Among numerous additives, LiBOB seems to be the only one that is multifunctional for the improvement of Li-ion batteries. Its synthetic procedure was first reported by Lischka et al. in 1999 (reference:PL1). However, this reaction was carried out in an aqueous solution, it is quite tedious to get pure product without trace of water. Then Xu et al. adopted a non-aqueous reaction in aprotic solvent to obtain LiBOB with high purity (reference:NPL7). Although there was no water involved in the reaction, which could meet the requirement of battery grade, this synthetic procedure requires not easily accessible precursors and multi-step operations.

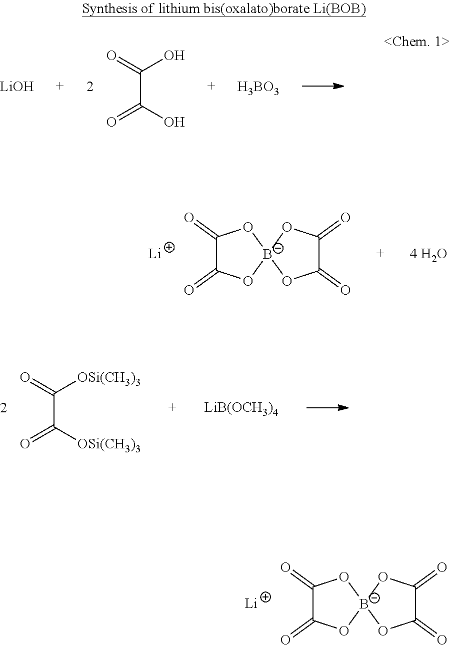

### CITATION LIST

### [Patent Literature (PL)]

1. “Lithium bisoxalatoborate used as conducting salt in lithium ion batteries”, Lischka, U.; Wietelmann, U.; Wegner, M. DE19829030C1, 1998.

### [Non-Patent Literature (NPL)]

1. “Electrolytes and interphases in Li-ion batteries and beyond”, Xu, K. Chem. Rev. 2014, 114, 11503-11618.
2. “Nonaqueous Liquid Electrolytes for Lithium-Based Rechargeable Batteries”, Xu, K. Chem. Rev. 2004, 104, 4303-4417.
3. “Functional lithium borate salts and their potential application in high performance lithium batteries”, Liu, Z.; Chai, J.; Xu, G.; Wang, Q.; Cui, G. Coord. Chem. Rev. 2015, 292, 56-73.
4. “A review on electrolyte additives for lithium-ion batteries”, Zhang, S. S. J. Power Sources 2006, 162, 1379-1394.
5. “Lithium salts for advanced lithium batteries: Li-metal, Li—O2, and Li—S”, Younesi, R.; Veith, G. M.; Johansson, P.; Edstrom, K.; Vegge, T. Energy Environ. Sci. 2015, 8, 1905-1922.
6. “Lithium-ion conducting electrolyte salts for lithium batteries”, Aravindan, V.; Gnanaraj, J.; Madhavi, S.; Liu, H. K. Chem. Eur. J. 2011, 17, 14326-14346.
7. “Weakly coordinating anions, and the exceptional conductivity of their nonaqueous solutions”, Xu, W.; Angellz, C. A. Electrochem. Solid-State Lett. 2001, 4, E1-E4.

### SUMMARY OF INVENTION

### Technical Problem

However, the availability of diversified functional lithium borate salts is quite limited due to the lack of efficient and versatile synthetic methods. Therefore, the development of efficient and versatile chemical transformations for the synthesis of diverse functional lithium borate salts from easily available starting materials is highly desirable.

The present invention has been made in view of the above problems, and an object of the present invention is to realize a novel method for producing a lithium boracarbonate ion pair, novel lithium boracarbonate ion pair, and use thereof.

### Solution to Problem

In view of the importance of lithium borates, cyclic carbonates and their combinations, we have developed a new strategy for the synthesis of lithium borate compounds containing both a cyclic carbonate structure and a borate unit in one molecule from easily available starting materials.

In order to attain the objects, the present invention includes at least one of the following aspects.

1) A method for producing a compound (i), including the step of:

reacting a compound (ii), a compound (iii), and carbon dioxide together in the presence of a copper catalyst and a lithium-based nucleophilic reagent,

the compound (ii) being represented by formula (1):

R3−C(R30)=X (1),

the compound (iii) being represented by formula (2):

(Z1)B−B(Z2) (2), and

the compound (i) being represented by formula (3):

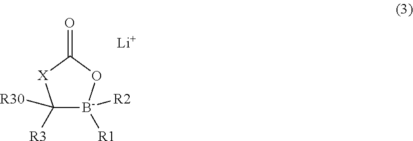

wherein X is O or NR4; Z1 and Z2 are each two hydroxyl groups, or are protecting groups for a boron atom (B) which protecting groups may be identical to or different from each other; R1 and R2 are each a group that is identical to Z1 or Z2, and may form a ring structure by binding to each other; R3 is any one selected from a hydrogen atom; an alkyl group; an alkenyl group; an alkynyl group; an aryl group; an aralkyl group; an alkylthio group; and an arylthio group each of which except the hydrogen atom may have a linear, branched, or cyclic structure; R30 is any one selected from a hydrogen atom; an alkyl group; an alkenyl group; an alkynyl group; an aryl group; an aralkyl group; an alkylthio group; and an arylthio group each of which except the hydrogen atom may have a linear, branched, or cyclic structure; and R4 is any one selected from an alkyl group; an alkenyl group; an alkynyl group; an aryl group; an aralkyl group; an alkylthio group; an arylthio group; an alkylsulfinyl group; an arylsulfinyl group; an alkylsulfonyl group; an arylsulfonyl group; an alkoxycarbonyl group; an aryloxycarbonyl group; a phosphoryl group; and a phosphonyl group each of which may have a linear, branched, or cyclic structure.

2) A compound represented by formula (3A):

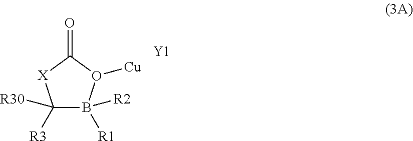

wherein Y1 is a ligand to a copper atom; X is O or NR4; R1 and R2 are each a hydroxyl group, or are protecting groups for a boron atom (B) which protecting groups may be identical to or different from each other, and may form a ring structure by binding to each other; R3 is any one selected from a hydrogen atom; an alkyl group; an alkenyl group; an alkynyl group; an aryl group; an aralkyl group; an alkylthio group; and an arylthio group each of which except the hydrogen atom may have a linear, branched, or cyclic structure; R30 is any one selected from a hydrogen atom; an alkyl group; an alkenyl group; an alkynyl group; an aryl group; an aralkyl group; an alkylthio group; and an arylthio group each of which except the hydrogen atom may have a linear, branched, or cyclic structure; and R4 is any one selected from an alkyl group; an alkenyl group; an alkynyl group; an aryl group; an aralkyl group; an alkylthio group; an arylthio group; an alkylsulfinyl group; an arylsulfinyl group; an alkylsulfonyl group; an arylsulfonyl group; an alkoxycarbonyl group; an aryloxycarbonyl group; a phosphoryl group; and a phosphonyl group each of which may have a linear, branched, or cyclic structure.

3) A compound represented by formula (3):

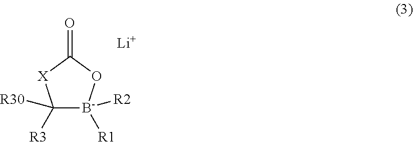

wherein X is O or NR4; R1 and R2 are each a hydroxyl group, or are protecting groups for a boron atom (B) which protecting groups may be identical to or different from each other, and may form a ring structure by binding to each other; R3 is any one selected from a hydrogen atom; an alkyl group; an alkenyl group; an alkynyl group; an aryl group; an aralkyl group; an alkylthio group; and an arylthio group each of which except the hydrogen atom may have a linear, branched, or cyclic structure; R30 is any one selected from a hydrogen atom; an alkyl group; an alkenyl group; an alkynyl group; an aryl group; an aralkyl group; an alkylthio group; and an arylthio group each of which except the hydrogen atom may have a linear, branched, or cyclic structure; and R4 is any one selected from an alkyl group; an alkenyl group; an alkynyl group; an aryl group; an aralkyl group; an alkylthio group; an arylthio group; an alkylsulfinyl group; an arylsulfinyl group; an alkylsulfonyl group; an arylsulfonyl group; an alkoxycarbonyl group; an aryloxycarbonyl group; a phosphoryl group; and a phosphonyl group each of which may have a linear, branched, or cyclic structure.

### Advantageous Effects of Invention

According to the present invention, it is possible to provide a novel method for producing a lithium boracarbonate ion pair, novel lithium boracarbonate ion pair, and use thereof.

### BRIEF DESCRIPTION OF DRAWINGS

FIG. 1 is a view illustrating an NMR Spectrum in Example of the present invention.

FIG. 2 is a view illustrating an NMR Spectrum in Example of the present invention.

FIG. 3 is a view illustrating an NMR Spectrum in Example of the present invention.

FIG. 4 is a view illustrating an NMR Spectrum in Example of the present invention.

FIG. 5 is a view illustrating an NMR Spectrum in Example of the present invention.

FIG. 6 is a view illustrating an NMR Spectrum in Example of the present invention.

FIG. 7 is a view illustrating an NMR Spectrum in Example of the present invention.

FIG. 8 is a view illustrating an NMR Spectrum in Example of the present invention.

FIG. 9 is a view illustrating an NMR Spectrum in Example of the present invention.

FIG. 10 is a view illustrating an NMR Spectrum in Example of the present invention.

FIG. 11 is a view illustrating an NMR Spectrum in Example of the present invention.

FIG. 12 is a view illustrating an NMR Spectrum in Example of the present invention.

FIG. 13 is a view illustrating an NMR Spectrum in Example of the present invention.

FIG. 14 is a view illustrating an NMR Spectrum in Example of the present invention.

FIG. 15 is a view illustrating an NMR Spectrum in Example of the present invention.

FIG. 16 is a view illustrating an NMR Spectrum in Example of the present invention.

FIG. 17 is a view illustrating an NMR Spectrum in Example of the present invention.

FIG. 18 is a view illustrating an NMR Spectrum in Example of the present invention.

FIG. 19 is a view illustrating an NMR Spectrum in Example of the present invention.

FIG. 20 is a view illustrating an NMR Spectrum in Example of the present invention.

FIG. 21 is a view illustrating an NMR Spectrum in Example of the present invention.

FIG. 22 is a view illustrating an NMR Spectrum in Example of the present invention.

FIG. 23 is a view illustrating an NMR Spectrum in Example of the present invention.

FIG. 24 is a view illustrating an NMR Spectrum in Example of the present invention.

FIG. 25 is a view illustrating an NMR Spectrum in Example of the present invention.

FIG. 26 is a view illustrating an NMR Spectrum in Example of the present invention.

FIG. 27 is a view illustrating an NMR Spectrum in Example of the present invention.

FIG. 28 is a view illustrating an NMR Spectrum in Example of the present invention.

FIG. 29 is a view illustrating an NMR Spectrum in Example of the present invention.

FIG. 30 is a view illustrating an NMR Spectrum in Example of the present invention.

FIG. 31 is a view illustrating an NMR Spectrum in Example of the present invention.

FIG. 32 is a view illustrating an NMR Spectrum in Example of the present invention.

FIG. 33 is a view illustrating an NMR Spectrum in Example of the present invention.

FIG. 34 is a view illustrating an NMR Spectrum in Example of the present invention.

FIG. 35 is a view illustrating an NMR Spectrum in Example of the present invention.

FIG. 36 is a view illustrating an NMR Spectrum in Example of the present invention.

FIG. 37 is a view illustrating an NMR Spectrum in Example of the present invention.

FIG. 38 is a view illustrating an NMR Spectrum in Example of the present invention.

FIG. 39 is a view illustrating a thermogravimetric analysis result in Example of the present invention.

FIG. 40 is a view illustrating an ionic conductivity in Example of the present invention.

FIG. 41 is a view illustrating a stable SEI layer formed on Li metal in Example of the present invention.

FIG. 42 is a view illustrating an electrochemical window in Example of the present invention.

FIG. 43 is a view illustrating an ORTEP drawing of 2a′ compound in Example of the present invention.

FIG. 44 is a view showing a result of a charge-discharge test on 2b in Example of the present invention.

### DESCRIPTION OF EMBODIMENTS

### [1. Novel Method for Producing a Lithium Boracarbonate Ion Pair, and Novel Lithium Boracarbonate Ion Pairs]

An aspect of the present invention relates to a compound (lithium boracarbonate ion pair) which is novel and is represented by the following formula (3), and to a method for producing the compound.

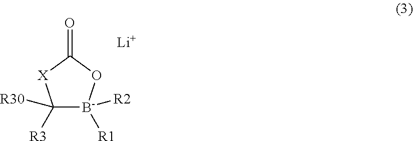

The method includes the step of reacting a compound represented by formula (1), a compound represented by formula (2), and carbon dioxide together in the presence of a copper catalyst and a lithium-based nucleophilic reagent.

R3−C(R30)=X (1)

(Z1)B−B(Z2) (2)

### Compound Represented by Formula (1))

In formula (1), X is O or NR4 (note that in a case where X is NR4, the N atom is a constituent atom of a five-membered ring of the compound represented by formula (3)) where R4 is any one selected from an alkyl group; an alkenyl group; an alkynyl group; an aryl group; an aralkyl group; an alkylthio group; an arylthio group; an alkylsulfinyl group; an arylsulfinyl group; an alkylsulfonyl group; an arylsulfonyl group; an alkoxycarbonyl group; an aryloxycarbonyl group; a phosphoryl group; and a phosphonyl group each of which may have a linear, branched, or cyclic structure. Note that in a case where X is O, the compound of formula (1) is aldehyde or ketone.

Further, in formula (1), R3 is any one selected from a hydrogen atom;an alkyl group; an alkenyl group; an alkynyl group; an aryl group; an aralkyl group; an alkylthio group; and an arylthio group each of which except the hydrogen atom may have a linear, branched, or cyclic structure.

Further, in formula (1), R30 is any one selected from a hydrogen atom; an alkyl group; an alkenyl group; an alkynyl group; an aryl group; an aralkyl group; an alkylthio group; and an arylthio group each of which except the hydrogen atom may have a linear, branched, or cyclic structure;.

Note here that the alkyl group is exemplified by, for example, linear or branched C1-C20, preferably C1-C10 alkyl groups such as a methyl group, an ethyl group, a propyl group (n-propyl group, isopropyl group), a butyl group (n-butyl group, s-butyl group, isobutyl group, t-butyl group), a pentyl group, a hexyl group, and a heptyl group; and cycloalkyl groups such as a cyclopentyl group and a cyclohexyl group. The aryl group is exemplified by, for example, a phenyl group, a naphthyl group, a thienyl group, a pyridyl group, a furyl group, a quinolyl group, and the like. The aralkyl group is exemplified by, for example, a benzil group (phenylmethyl group), a phenylethyl group, and the like. The alkylthio group is exemplified by, for example, a group represented by R—S-assuming that R is the alkyl group mentioned above. The arylthio group is exemplified by, for example, a group represented by R—S-assuming that R is the aryl group mentioned above. The alkylsulfonyl group is exemplified by, for example, a group represented by R—S(O)₂-assuming that R is the alkyl group mentioned above. The arylsulfonyl group is exemplified by, for example, a group represented by R—S(O)₂-assuming that R is the aryl group mentioned above. Note that each of these groups may have a substituent group such as a C1-C4 alkyl group, a halogen group, a C1-C4 alkyl halide group, a C1-C4 alkoxy group, a C1-C4 alkylthio group, an amino group or the like.

### (Compound Represented by Formula (2))

The compound represented by formula (2) is a diboron compound having a B—B bond in a molecule thereof.

In formula (2), Z1 and Z2 each represent two hydroxyl groups. Specifically, in this case, the compound represented by formula (2) is diboronic acid represented by (OH)₂B—B(OH)₂.

In formula (2), Z1 and Z2 are preferably protecting groups Z for a boron atom (B) which protecting groups Z may be identical to or different from each other. As such a protecting group Z, it is appropriately employ, for example, a protecting group that is known as a protecting group for boronic acid.

The protecting group Z is exemplified by, for example, a group represented by —OR, —NHR, or the like. In this case, the compound of formula (2) is represented by (Z)₂B—B(Z)₂ assuming that Z represents —OR or —NHR. Note that R is exemplified by, for example, linear or branched C1-C20, preferably C1-C10 alkyl groups such as a methyl group, an ethyl group, a propyl group (n-propyl group, isopropyl group), a butyl group (n-butyl group, s-butyl group, isobutyl group, t-butyl group), a pentyl group, a hexyl group, and a heptyl group; cycloalkyl groups such as a cyclopentyl group and a cyclohexyl group; aryl groups such as a phenyl group, a naphthyl group, a thienyl group, a pyridyl group, a furyl group, and a quinolyl group; and the like.

Further, two protecting groups Z that bind to a single B atom more preferably form one ring structure by binding to each other. Specifically, for example, the compound of formula (2) preferably forms a structure represented by the following formula (2-1) or formula (2-2).

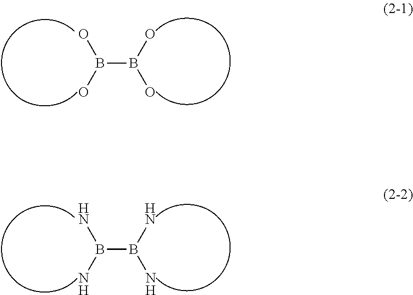

A protecting group in formula (2-1) or formula (2-2) is more specifically exemplified by, for example, protecting groups having the following structures. The following structures each represent only a protecting group (Z1 or Z2) for one of boron atoms. Note, however, that the other of the boron atoms is also protected by a similar protecting group.

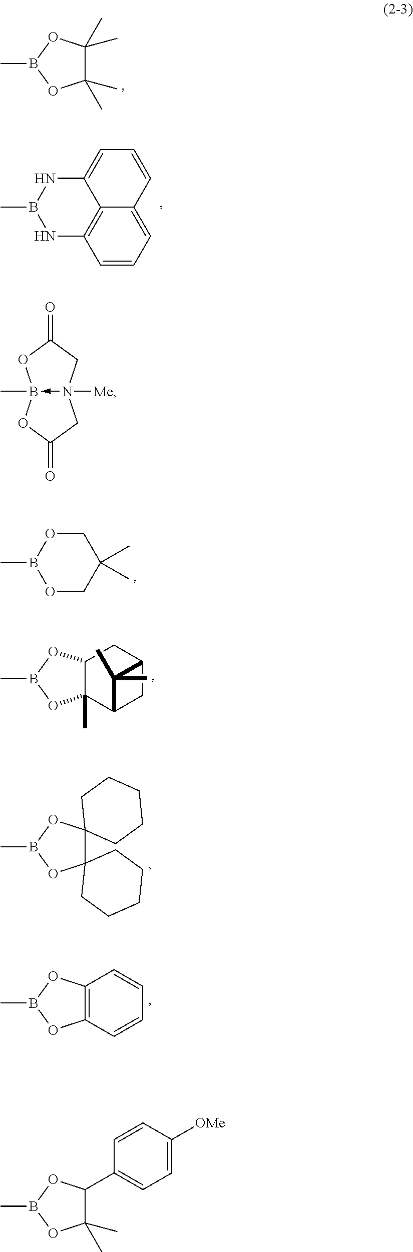

### (Compound Represented by Formula (3))

X, R3, and R30 in formula (3) are identical to X, R3, and R30, respectively, in formula (1). R1 and R2 in formula (3) are each a group that is identical to Z1 or Z2 in formula (2), and may form a ring structure by binding to each other.

A compound represented by formula (3) has a chemical structure formed by B-, and R1 and R2 each of which binds to B-, the chemical structure being preferably represented by the following formula (3-1) or (3-2):

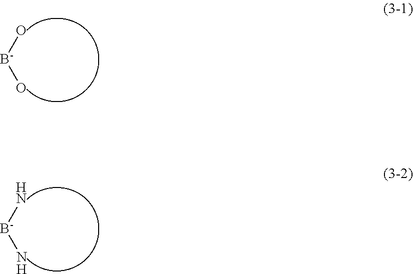

A more specific example of the structure represented by the above formula (3-1) or (3-2) corresponds to a structure represented as formula (2-3). Note, however, that B in formula (2-3) is read as B-.

Note that after the compound represented by formula (3) is obtained, it is possible to prepare a derivative by appropriately chemically modifying the obtained compound. For example, it is also possible to introduce appropriate substituent group(s) into R1, R2, R3, R30, and/or R4 (in the case where X is NR4) in formula (3), or to substitute other appropriate substituent group(s) for a hydrogen atom which binds to a five-membered ring skeleton in formula (3), R1, R2, R3, R30, and/or R4 (in the case where X is NR4) in formula (3). Appropriate substituent group(s) which may be substituted for R1 and/or R2 in formula (3) is/are specifically exemplified by, for example, fluoro group(s).

### (Lithium-Based Nucleophilic Reagent)

The lithium-based nucleophilic reagent is specifically exemplified by, for example, metallic lithium, lithium hydroxide (LiOH) and an organic lithium reagent. The lithium-based nucleophilic reagent is preferably an organic lithium reagent. Of organic lithium reagents, a reagent selected from alkyl lithiums such as methyl lithium, ethyl lithium, (n-, sec-, t-)butyl lithium, and phenyl lithium; lithium alkoxides such as lithium methoxide, lithium ethoxide, lithium(n-, sec-, t-)butoxide, and lithium phenoxide; and lithium amides such as lithium diisopropyl amide (LDA), lithium 2,2,6,6-tetramethylpiperidine (LiTMP), and lithium hexamethyldisilazide (LHMDS) is preferable, a reagent selected from lithium alkoxides or lithium amides is more preferable, and a reagent selected from lithium alkoxides is still more preferable.

### (Copper Catalyst)

The copper catalyst is specifically exemplified by, for example, metallic coppers; copper (I) halides such as CuF, CuCl, CuB, and Cul; copper salts such as copper (I) cyanide, trifluoromethane sulfonate copper, copper acetate, copper hexafluorophosphate, and copper sulfate; N-hetero-cyclic carbene (NHC)-copper catalysts, i.e., copper catalysts each having an NHC ligand such as IPr, ICy, IMes, SIMe, or SIPr; and the like. Of these copper catalysts, an NHC-copper catalyst is preferable. Note that an NHC-copper catalyst may have a halogen ligand in addition to an NHC ligand.

### (Method for Producing Compound Represented by Formula (3))

An embodiment of a method in accordance with the present invention includes the step of reacting the compound represented by formula (1), the compound represented by formula (2), and the carbon dioxide together in the presence of the copper catalyst and the lithium-based nucleophilic reagent.

The above step may be carried out as one step by simultaneously or sequentially pouring the above-mentioned materials etc. into a single reaction system, or may be carried out by being divided into a plurality of steps.

According to an aspect of the present invention, the above reaction step is preferably carried out in a form of a reaction in a solvent. The solvent only needs to be selected in accordance with the materials etc. Specifically, for example, the solvent only needs to be appropriately selected from solvents that cause no undesirable reaction with the materials etc. and are capable of dissolving or dispersing the materials etc. According to an aspect, the solvent is a nonaqueous solvent, and is preferably an aprotic solvent. The aprotic solvent is specifically exemplified by, for example, hydrocarbon solvents such as hexane and benzene; aprotic ether solvents such as dioxane and tetrahydrofuran (THF); dimethylsulfoxide (DMSO), dimethylformamide (DMF), and the like; a mixed solvent of these solvents; and the like. Of these aprotic solvents, a hydrocarbon solvent; an aprotic ether solvent; a mixed solvent of these solvents; or the like is more preferable.

The reaction step is carried out at a reaction temperature of 0° C. to 150° C. according to an aspect, and preferably 20° C. to 120° C., and at a reaction pressure of approximately 1 atm to 20 atm, and more preferably approximately 1 atm to 10 atm. Note that for example, in a case where the solvent is refluxed, the reflux may be carried out at, for example, a temperature and a pressure each of which allows evaporation of the solvent. Further, a reaction time of the reaction step is 5 hours to 40 hours according to an aspect, and preferably 10 hours to 30 hours.

Note that of the materials etc., the compound represented by formula (1), the compound represented by formula (2), the carbon dioxide, and the lithium-based nucleophilic reagent can react together in equimolar quantities in principle. Thus, in a case where the compound represented by formula (1) is poured into the reaction system in 1 molar equivalent, the compound represented by formula (2) and the lithium-based nucleophilic reagent only need to be poured in approximately 1 molar equivalent to 3 molar equivalents according to an aspect, preferably approximately 1 molar equivalent to 2 molar equivalents, and more preferably 1 molar equivalent to 1.5 molar equivalents. According to an aspect, the carbon dioxide is a gas that is pressed (e.g., under not more than 10 atm or 5 atm) so as to be more dissolvable in the solvent, and the gas may be supplied in an excess amount.

According to an aspect, the copper catalyst is supplied so as to have, in the solvent, a concentration falling within a range of 0.5 mol % to 10 mol %, and more preferably of 1 mol % to 6 mol %.

Further, the method can appropriately include a step of purifying a reaction product and other step(s) in addition to the reaction step.

According to an aspect, the reaction step includes the step of reacting a compound represented by formula (3A) and the lithium-based nucleophilic reagent together so as to obtain the compound represented by formula (3).

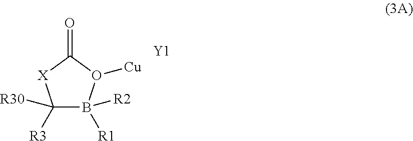

Note that R1, R2, R3, R30, and X in the above formula (3A) are identical in definition to R1, R2, R3, R30, and X, respectively, in formula (3). In the above formula (3A), Y1 is a ligand of the copper catalyst which ligand coordinates to a copper atom. For example, in a case where a copper (I) halide is used as the copper catalyst, Y1 is a halogen ligand. Meanwhile, in a case where an NHC-copper catalyst is used as the copper catalyst, Y1 is an NHC ligand.

Note that the compound represented by formula (3A) can be easily obtained by, for example, a reaction in the solvent by use of the compound represented by formula (1), the compound represented by formula (2), the carbon dioxide, the copper catalyst, and the lithium-based nucleophilic reagent (see also Examples).

### [2. Application of Novel Compound]

### (Application of the Compound Represented by Formula (3A))

An example of application of this compound is, as described earlier, a material of which to produce the compound represented by formula (3). Another example of application of this compound is a material of which to produce Boracarbonate Ion Pair into which any metal ion except lithium ion is introduced. Further, this compound can also be used as a material of which to produce other compound(s).

### (Application of the Compound Represented by Formula (3))

An example of application of this compound is an electrolyte of a lithium ion battery. For example, this compound which is dissolved, in a known solvent, as a solvent of an electrolyte of a lithium ion battery can be used as a liquid electrolyte or a gel electrolyte of the lithium ion battery.

Note that it is only necessary to appropriately employ, as constituent elements (a cathode, an anode, a separator, a cell, etc.) other than the electrolyte, constituent elements that are known as constituent elements of a lithium ion battery.

The present invention is not limited to the embodiments, but can be altered by a skilled person in the art within the scope of the claims. An embodiment derived from a proper combination of technical means each disclosed in a different embodiment is also encompassed in the technical scope of the present invention.

This Nonprovisional application claims priority on Patent Application No. 10-2017-0045206 filed in Korea on Apr. 7, 2017, the entire contents of which are hereby incorporated by reference.

### EXAMPLES

Hereinafter, the present invention will be described more specifically by way of Examples, but the scope of the present invention is not intended to be limited to the following Examples

### Example 1

We began with examining the reaction of benzaldehyde with 1.0 equiv of B₂(pin)₂ and 1.1 equiv of LiOtBu under a CO₂ atmosphere by using various N-heterocyclic carbene (NHC) copper complexes as catalysts (Table 1).

TABLE 1
Cu-catalyzed coupling of benzaldehyde with
B₂(pin)₂ and CO₂.^{[a]}

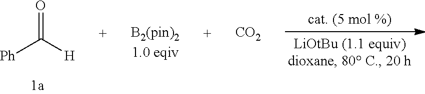

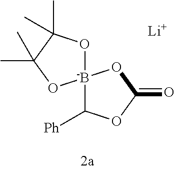

| | | CO₂ | |
|---|---|---|---|
| Entry | Cat. | Pressure | Yield (%)^{[b]} |
| 1 | [(IPr)CuCl] | 1 atm | trace |
| 2 | [(IPr)CuCl] | 5 atm | 35 |
| 3 | [(ICy)CuCl] | 5 atm | 73 |
| 4 | [(IMes)CuCl] | 5 atm | 82 |
| 5 | [(SIMes)CuCl] | 5 atm | 85 |

^{[a]}Reaction conditions: cat. (5 mol %), B₂(pin)₂ (0.5 mmol), benzaldehyde (0.5 mmol), LiOtBu (1.1 equiv), dioxane (3.0 mL), CO₂, 80° C., 20 h.
^{[b]}Isolated yields.

When the reaction was carried out under 1 atm of CO₂ with [(IPr)CuCl] (IPr=1,3-bis(2,6-diisopropylphenyl)imidazol-2-ylidene) as a catalyst, a lithium cyclic boracarbonate ion pair product 2a was obtained only in a trace amount (entry 1). To our delight, raising the CO₂ pressure to 5 atm led to isolation of 2a in 35% yield (entry 2). Remarkably, the use of copper catalysts bearing more electron-donating NHC ligands, such as [(ICy)CuCl] (ICy=1,3-dicyclohexylimidazol-2-ylidene) and [(IMes)CuCl] (IMes=1,3-bis(2, 4, 6-trimethylphenyl)imidazol-2 -ylidene), afforded the desired product 2a in much higher yields (entries 3 and 4). When the saturated NHC-ligated catalyst [(SIMes)CuCl] (SIMes=1,3-bis(2, 4, 6-trimethylphenyl)imidazolin-2-ylidene) was used, the yield of 2a was further improved to 85% (entry 5).

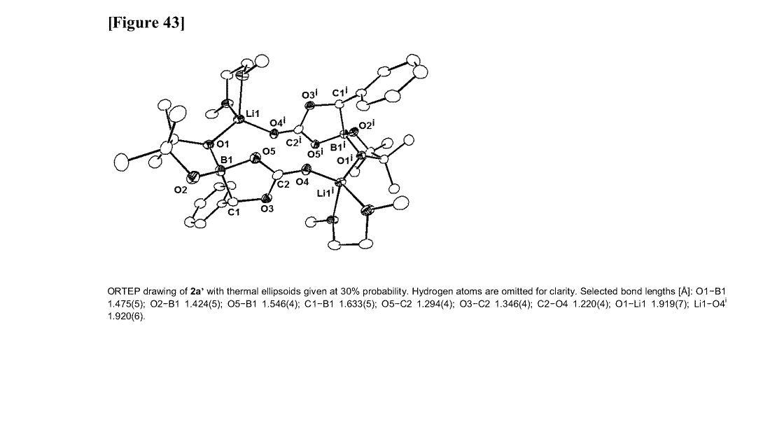

Recrystallization of 2a in DME yielded single crystals of 2a′ suitable for X-ray crystallographic studies. It was revealed that 2a′ adopts a dimeric structure of two novel boracarbonate units (FIG. 43). The unique five-membered ring of the boracarbonate is built up by connection of the two oxygen atoms of the carbonate group with a B—C bond. The two boracarbonate units are each bonded to two Li atoms by using the carbonate carbonyl oxygen atom and a pinacolate oxygen atom. The Li atoms are tetrahedral coordinated with two oxygen atoms of the DME ligands, one carbonate carbonyl oxygen atom and one pinacolate oxygen atom. The DME solvent ligands in 2a′ could be removed in vacuo to give the DME-free 2a, as confirmed by NMR and elemental analyses.

Under the optimized reaction conditions described above, we then investigated the scope of aldehydes for the present coupling reaction with CO₂ and B₂(pin)₂ (Table 2).

TABLE 2
Cu-catalyzed coupling of various aldehydes with B₂(pin)₂ and CO₂.^{[a]}

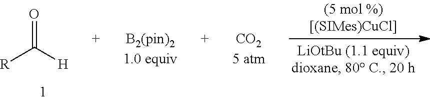

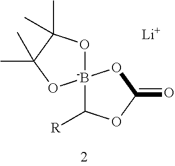

| | |
|---|---|
| 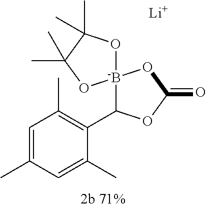 | 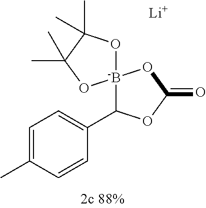 |
| 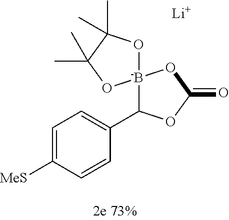 | 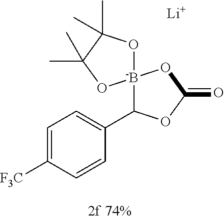 |
| 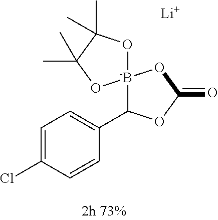 | 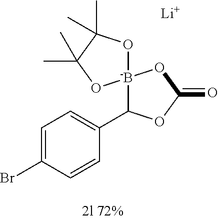 |
| 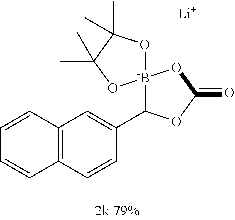 | 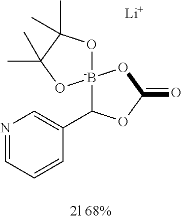 |
| 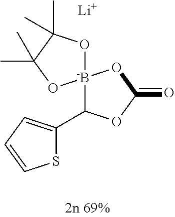 | 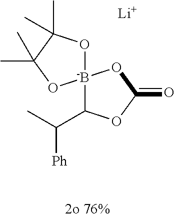 |
| 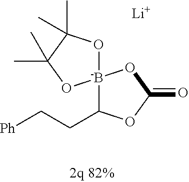 | 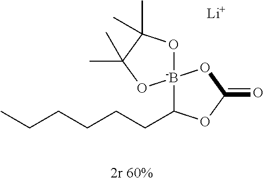 |

^{[a]}Reaction conditions: [(SIMes)CuCl] (5 mol %), B₂(pin)₂ (0.5 mmol), aldehyde (0.5 mmol), LiOtBu (1.1 equiv), dioxane (3.0 mL), CO₂ (5 atm), 80° C., 20 h. Product yields are given in isolated yields.

Various aromatic aldehydes bearing either electron-donating or electron-withdrawing groups are suitable for this reaction, affording the desired products in good to excellent yields. For example, the reaction of sterically demanding mesitaldehyde occurred smoothly to give the multi-component cyclic coupling product 2b in 71% isolated yield. The MeO—, MeS—, and CF₃-substituted benzaldehyde substrates were easily transformed to the desired ion pair products 2d, 2e, and 2f, respectively. Aromatic C—X (X═F, Cl, Br, I) bonds are compatible with the reaction conditions, affording the corresponding halogenated products 2g-j in good yields. 2-Naphthaldehyde and heteroaromatic aldehydes containing pyridine, furan, and thiophene rings are also applicable, efficiently yielding the desired products 2k-n. In addition to aromatic aldehydes, various aliphatic aldehydes could also be used as suitable substrates for this reaction, giving the corresponding cyclic boracarbonate products (2o-r) in generally high yields.

To gain information on the reaction mechanism of the present catalytic process, we then examined the stoichiometric reaction of a borylcopper complex [(IPr)CuB(pin)], formed by the reaction of [(IPr)Cu(OtBu)] with B₂(pin)₂, with mesitaldehyde under 5 atm of CO₂ (Scheme 1).

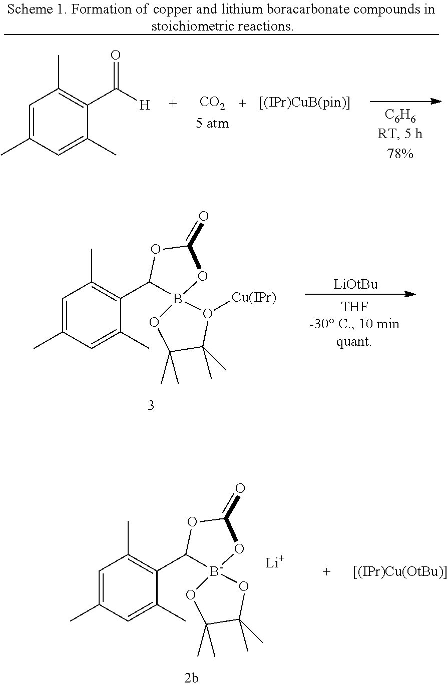

A cyclic boracarbonate complex with a (IPr)Cu unit (3) was isolated in 78% yield. The reaction of 3 with 1 equiv of LiOtBu in THF quantitatively afforded the lithium ion pair product 2b and the copper alkoxide [(IPr)Cu(OtBu)].

On the basis of the above experimental observations, a possible mechanism for the current catalytic multi-component coupling reaction is proposed in Scheme 2.

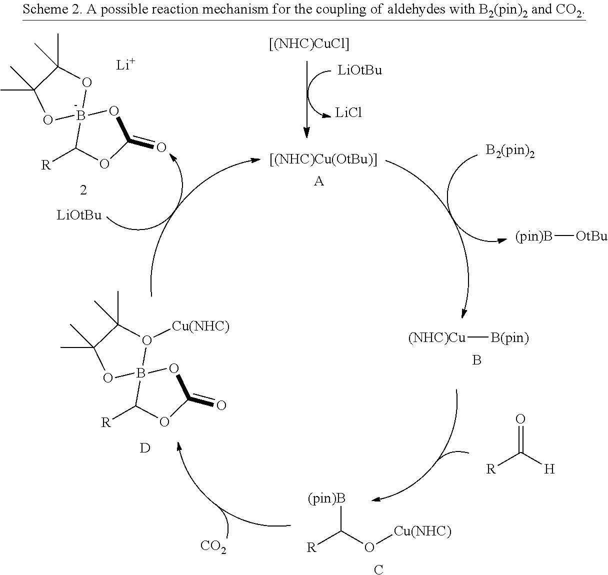

The initial metathesis reaction between [(NHC)CuCl] and LiOtBu would afford a copper alkoxide [(NHC)Cu(OtBu)] (A), which upon reaction with B₂(pin)₂ could generate the boryl copper complex [(NHC)CuB(pin)] (B). The subsequent insertion of an aldehyde into the Cu—B bond would give the copper alkoxide C. Insertion of CO₂ into the Cu—O bond in C followed by migration of the copper unit from the resulting carbonate group to a pinacolate oxygen atom and intramolecular B—O (carbonate) bond formation would generate the cyclic boracarbonate derivative D. Transmetallation between the copper complex D and LiOtBu should regenerate the copper tert-butoxide active species A and release the final lithium boracarbonate ion pair product 2.

It is remarkably amazing that the current multi-component coupling reaction took place so selectively and efficiently even though a number of side reactions could be possible, such as the carboxylation of the copper tert-butoxide A with CO₂, the reduction of CO₂ to CO by the copper boryl species B, the rearrangement of the copper alkoxide C to an (α-boroxy)benzylcopper complex, and the metathesis between copper complex C with LiOtBu. The present selective formation of B from the reaction of A with B₂(pin)₂ and the selective formation of C from the reaction of B with an aldehyde demonstrate that the possible competition reactions of the tert-butoxide A and the boryl species B with CO₂ are much slower. Similarly, the selective formation of D from the reaction of C with CO₂ may suggest that the reaction between the boryl-substituted alkoxide C and CO₂ is much faster than that between the tert-butoxide A and CO₂ and the metathesis reaction of C and LiOtBu, and it is even faster than the intramolecular boryl-copper migration reaction in C.

In summary, we have developed a new strategy for the synthesis of lithium borate compounds from easily available starting materials. By one-pot coupling of CO₂, B₂(pin)₂, aldehydes, and LiOtBu in the presence of an NHC-copper catalyst, we have successfully synthesized a new class of lithium cyclic boracarbonate ion pair compounds, which might be of interest as potential electrolyte candidates for lithium ion batteries in view of their unique structure features. The novel boron-implanted cyclic carbonate structure was constructed by the nucleophilic addition of a copper boryl species to an aldehyde and the subsequent CO₂ insertion into the resulting Cu—O bond followed by ring closing through B—O (carbonate) bond formation. These transformations took place sequentially and selectively by competing against a number of possible side reactions. The present multi-component coupling reaction has not only provided a new class of lithium borate compounds, but it has also constituted a new efficient process for CO₂ utilization. Studies on the electrochemical properties of the lithium boracarbonate compounds obtained in this work and the synthesis of new lithium borate ion pair compounds by reaction of CO₂ with other substrates are in progress.

### General Information

Unless otherwise noted, all manipulations were carried out under a dry nitrogen atmosphere by using standard Schlenk techniques or by using an MBRAUN Labmaster 130 glovebox. Nitrogen gas was purified by being passed through a Dryclean column (4 Å molecular sieves, Nikka Seiko Co.) and a Gasclean GC-RX column (Nikka Seiko Co.).

THF and benzene were purified by an MBRAUN SPS-800 Solvent Purification System and dried over fresh Na chips in a glovebox. Anhydrous 1,4-dioxane and 1,2-dimethoxyethane were purchased from Aldrich in Sure-Seal™ bottles, and used without purification. Deuterated dimethyl sulfoxide was degassed by three freeze-pump-thaw cycles and stored under nitrogen over 4 Å molecular sieves. The aldehydes were purified by recrystallization or distillation before use and stored under an inert atmosphere of nitrogen. [(IPr)CuCl], [(ICy)CuCl], [(IMes)CuCl], [(SIMes)CuCl]¹, and [(IPr)CuB(pin)]² were synthesized according to literature procedures. Carbon dioxide and other commercially available reagents were used without further purification.

The NMR spectra were recorded on a JEOL ECS-400, JEOL ECA-500 or Bruker AV-500 spectrometers. Data are reported as follows: chemical shift (δ) expressed in ppm relative to the residual solvent peak, multiplicity (s=singlet, d=doublet, t=triplet, q=quartet, m=multiplet, br=broad signal), coupling constant (Hz), and integration. High Resolution Mass spectra were obtained on a Bruker micrOTOF-Q III (ESI⁻) instrument. Elemental analyses were conducted by a MICRO CORDER JM10 instrument. X-ray diffraction data of the complex 2a′ was collected on a Bruker D8 QUEST diffractometer with a CMOS area detector using graphite-monochromated MoK_{α} radiation (λ=0.71073 Å).

### Synthetic Procedures

### Typical Procedure for the Multi-Component Coupling of Benzaldehyde:

In a glovebox, a 50 mL stainless steel autoclave equipped with a magnetic stirring bar was charged with [(SIMes)CuCl] (10.1 mg, 0.025 mmol), B₂(pin)₂ (127 mg, 0.50 mmol), LiOtBu (44 mg, 0.55 mmol), and benzaldehyde 1a (53 mg, 0.50 mmol) in 1,4-dioxane (3 mL). The autoclave was sealed and taken out of glovebox. After the reaction mixture was subjected to vacuum for a while under stirring, the stirring was stopped and CO₂ gas (5 atm) was introduced. The mixture was then heated in an oil bath at 80° C. for 20 h under vigorous stirring. After the autoclave was cooled down to room temperature, the residual CO₂ was evacuated under vacuum. The autoclave was taken back into the glovebox and the solvent was removed under reduced pressure. The residue was dissolved in a large amount of DME. The solution was filtered with a sintered disc filter funnel (P16) and the clear filtrate was concentrated under vacuum. The product was then purified by recrystallization from its DME/hexane solution at −30 ° C. The desired product 2a was obtained after removal of the coordinated DME solvent molecule under vacuum as a white solid (120.7 mg, 85% yield). Single crystals suitable for X-ray analysis were obtained by cooling a saturated DME solution at −30° C.

### Synthesis of Complex 3:

A solution of mesitaldehyde (22.9 μL, 0.16 mmol) in C₆H₆ (1 mL) was added into a 100 mL stainless steel autoclave equipped with a needle valve. Under a CO₂ gas flow (1 atm), a solution of [(IPr)CuB(pin)] (90 mg, 0.16 mmol) in C₆H₆ (1 mL) was added directly inside the aldehyde solution with a syringe. Under stirring, the pressure of CO₂ was raised to 5 atm. The autoclave was sealed and the reaction mixture was stirred at room temperature for 5 h. The residual CO₂ was evacuated under vacuum and the autoclave was brought into a glovebox. The resulting white precipitate was filtered and washed with C₆H₆ (1 mL×2). The desired product 3 was obtained as a white solid (96.2 mg, 78% yield).

Reaction of Complex 3 with LiOtBu:

LiOtBu (0.056 mmol, 4.5 mg) was added into a THF (2 mL) solution of complex 3 (0.056 mmol, 43 mg) at −30° C. After stirring for 10 min, THF was evaporated. The reaction mixture was extracted with C₆D₆, and the residual solid was dissolved in THF-d₈. The formation of [(IPr)Cu(OtBu)] was confirmed by NMR analysis of the C₆D₆ solution. The formation of 2b was confirmed by NMR analysis of the THF-d₈ solution.

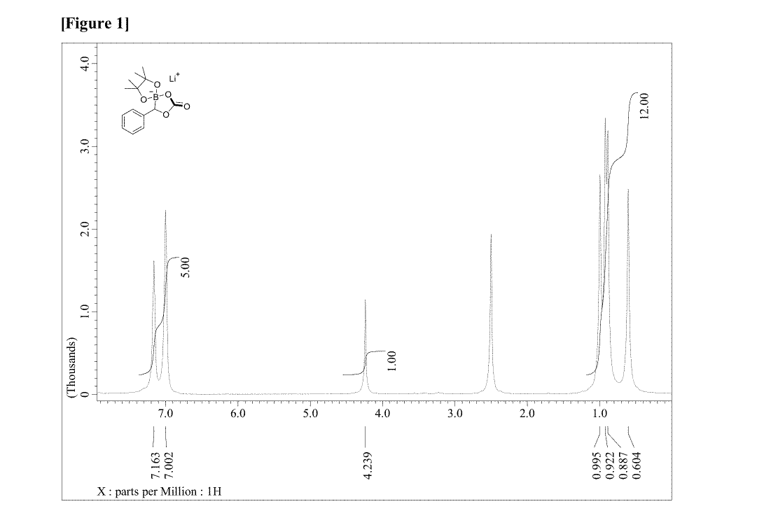

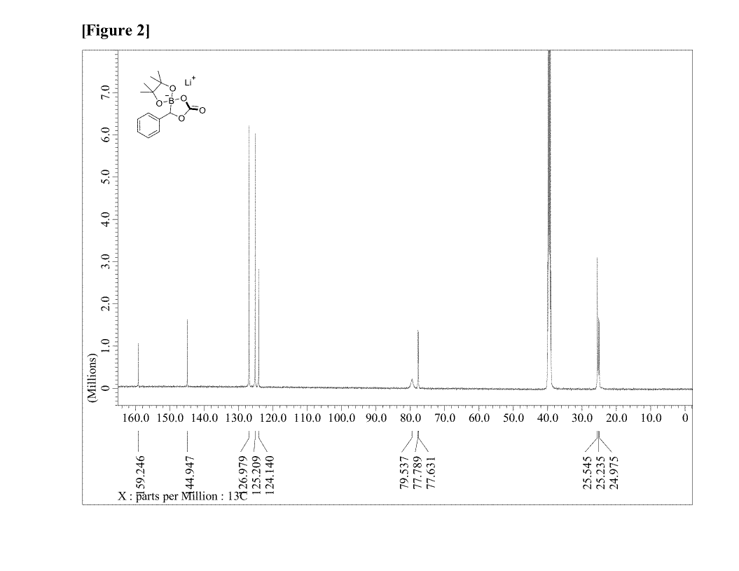

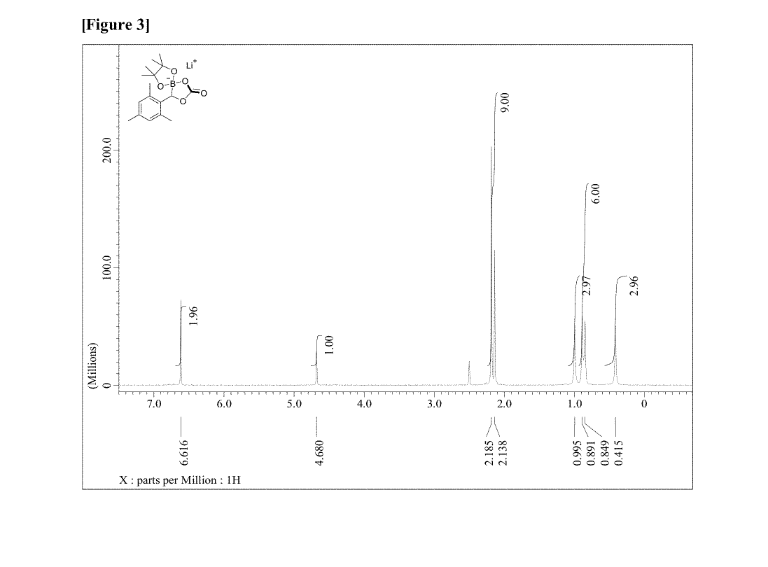

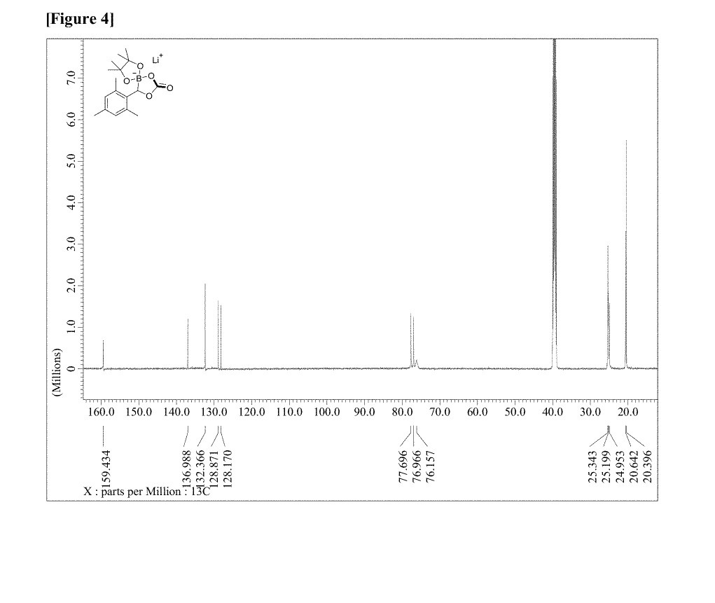

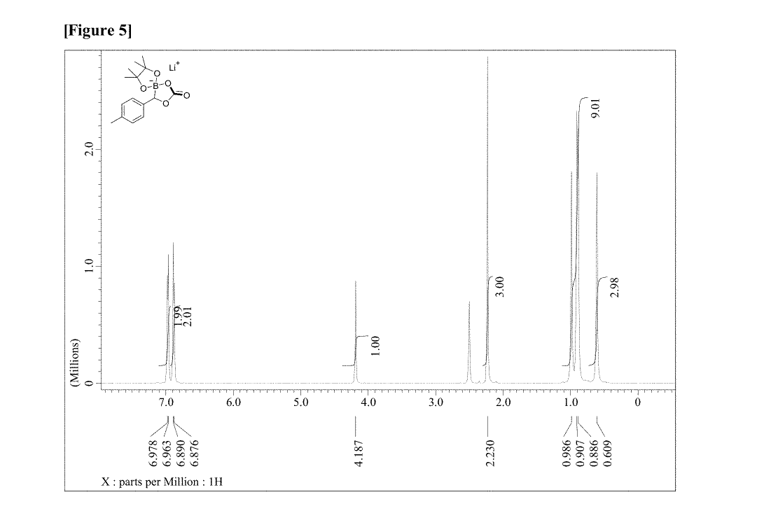

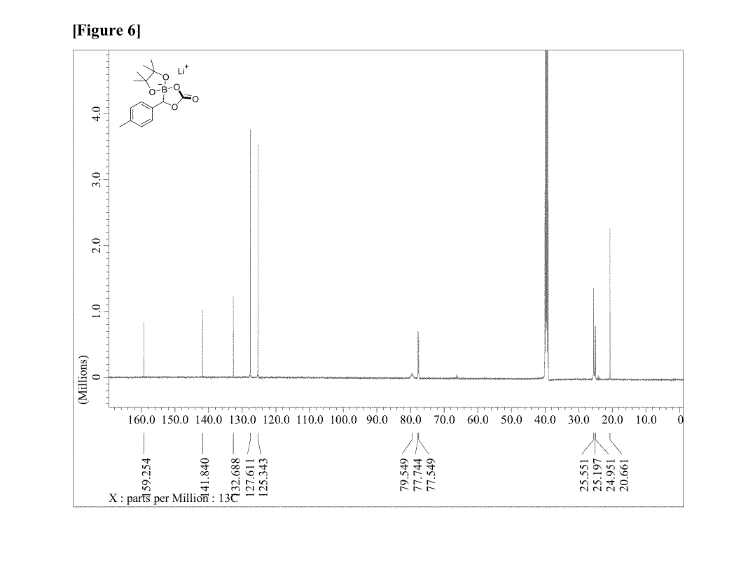

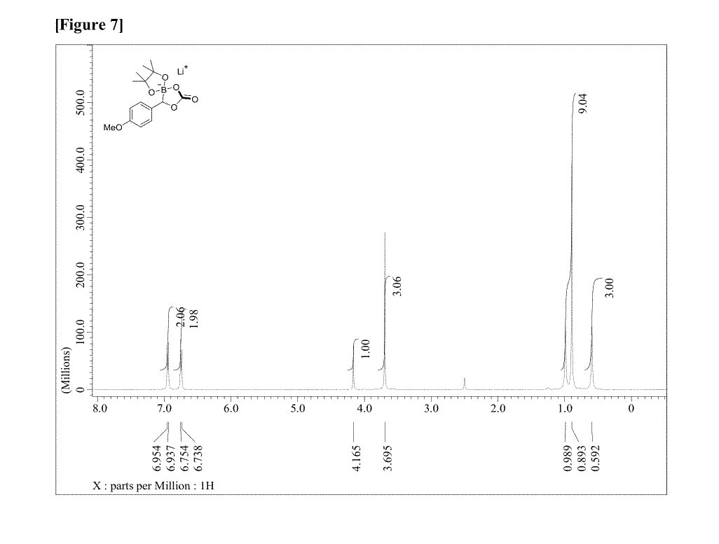

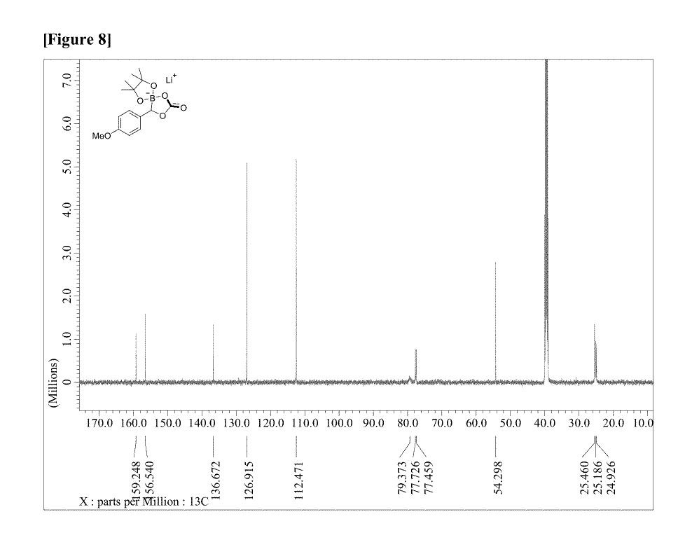

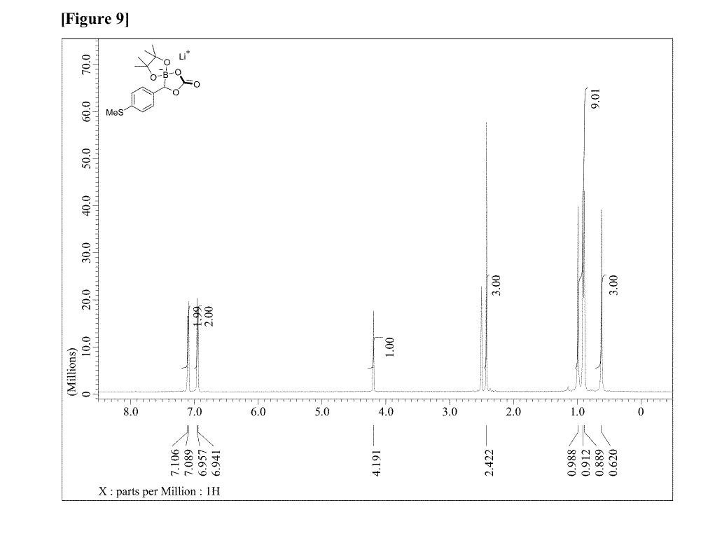

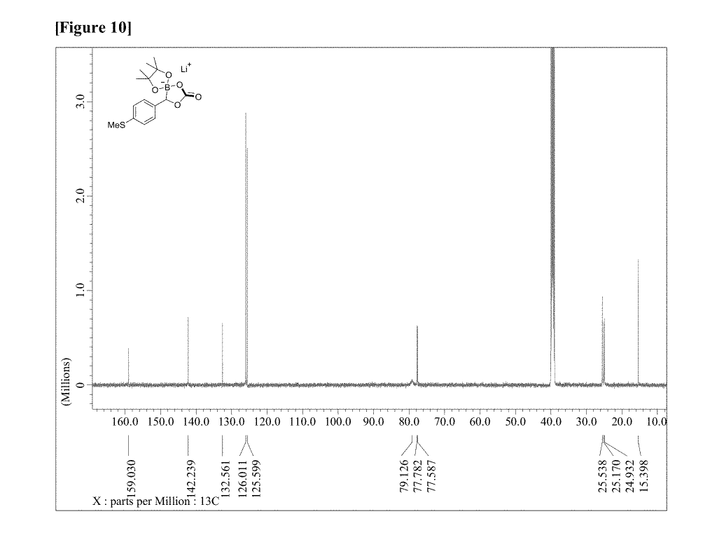

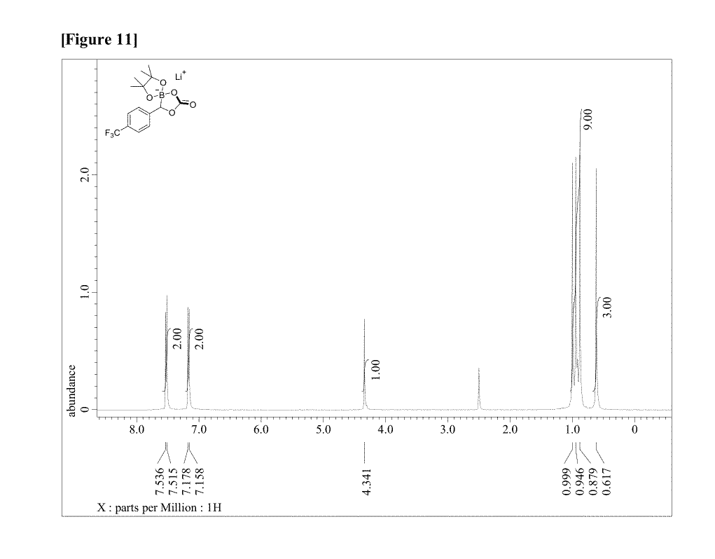

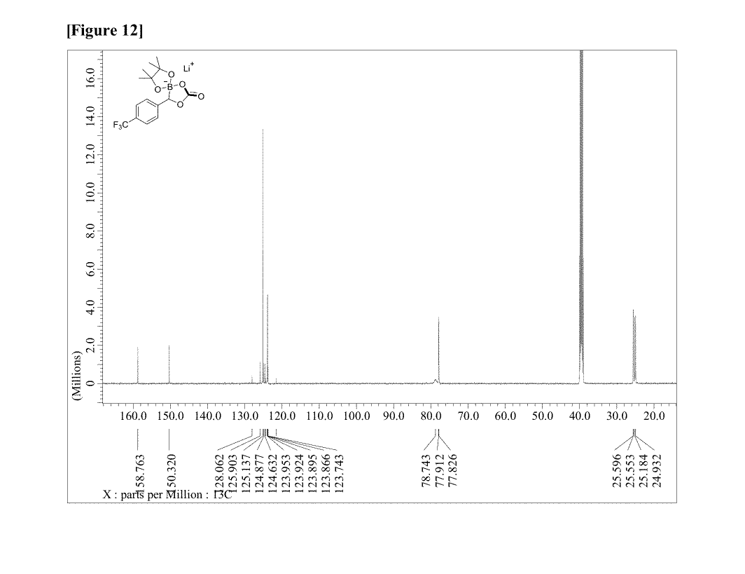

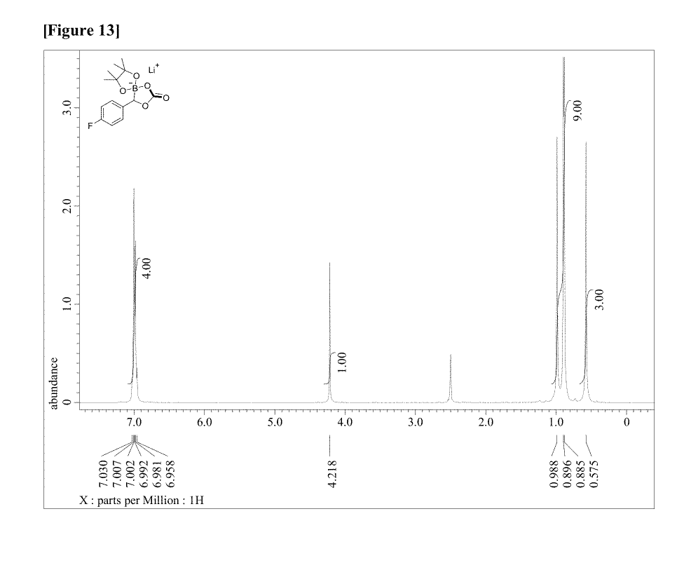

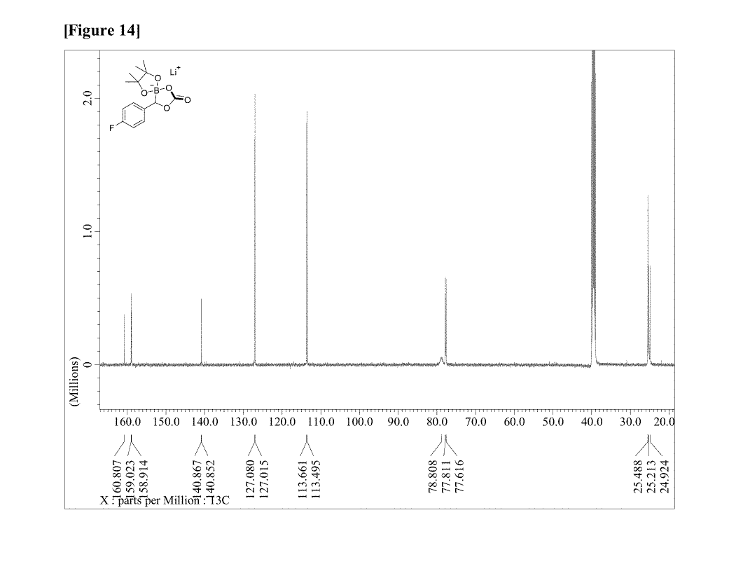

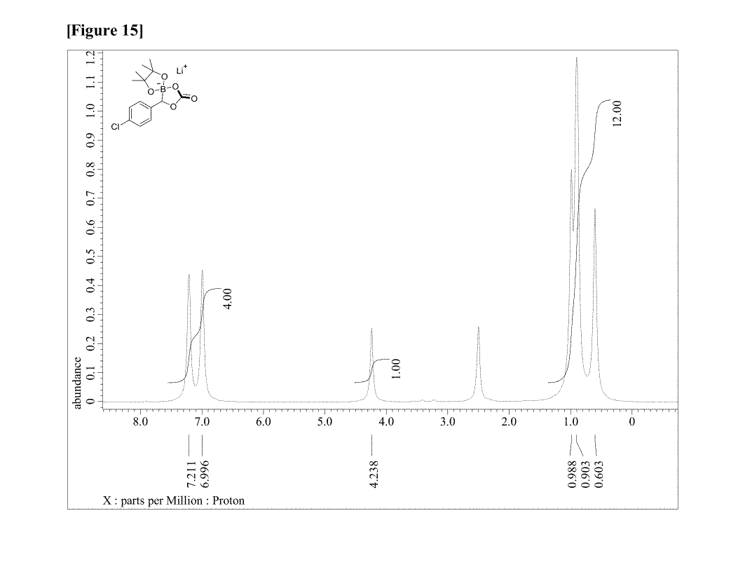

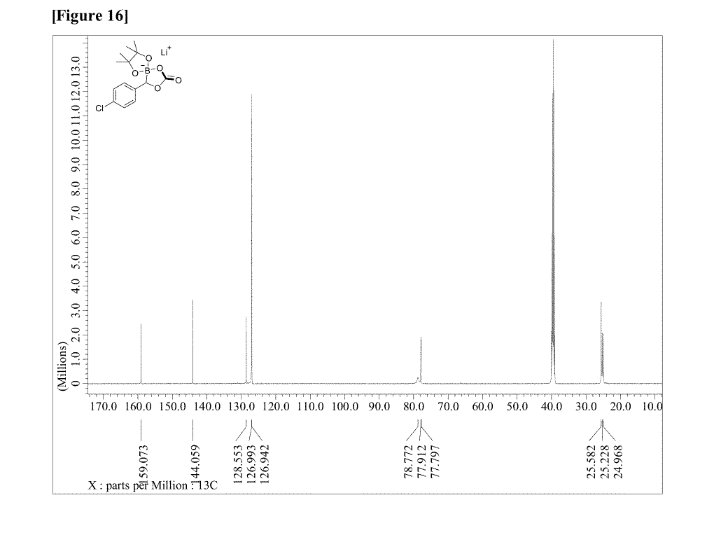

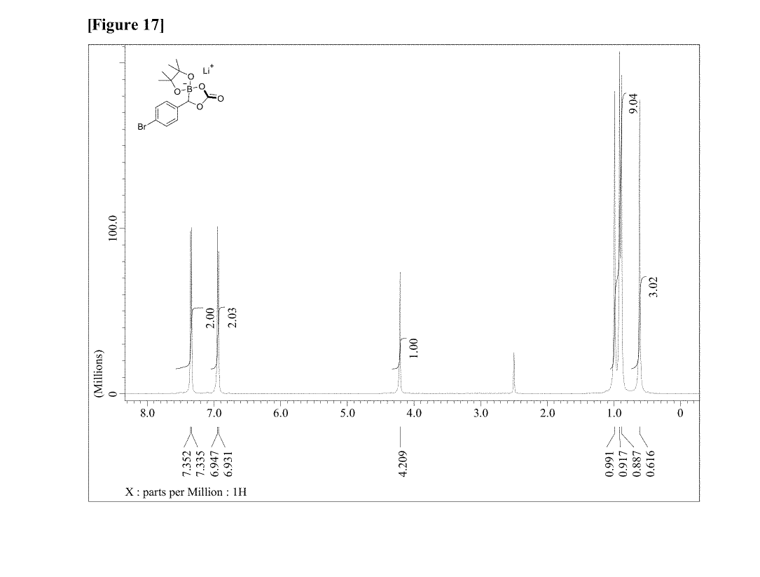

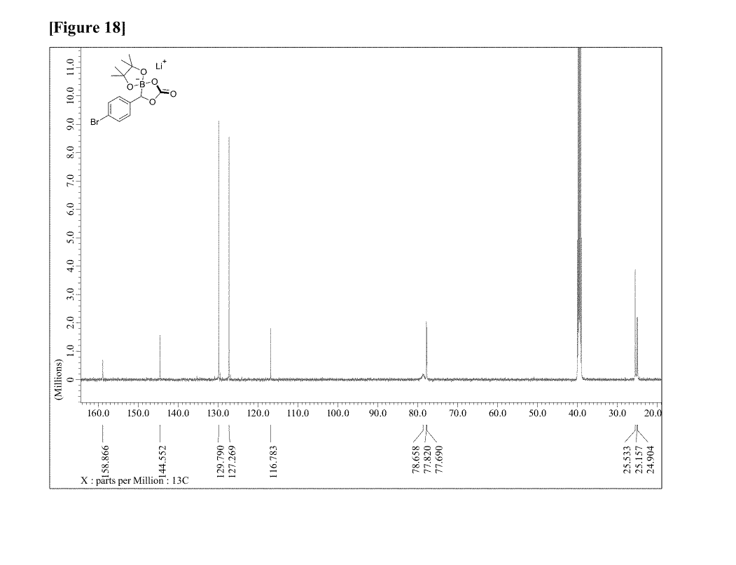

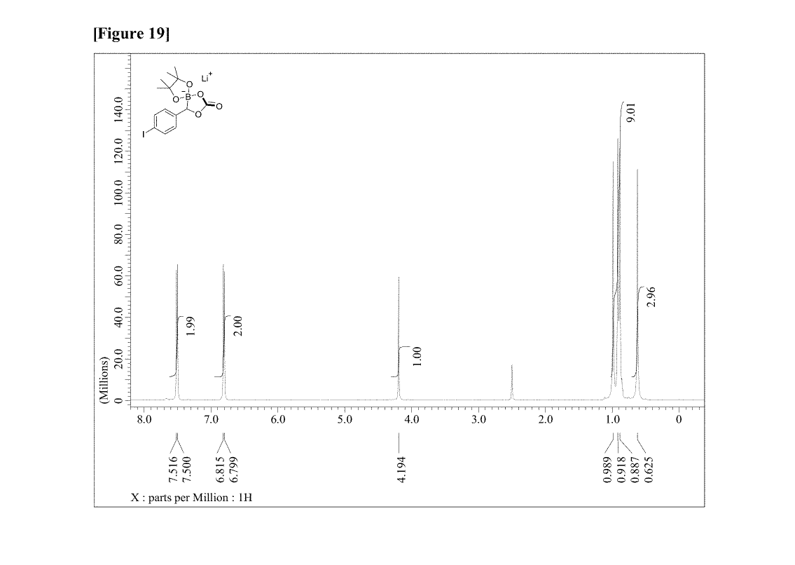

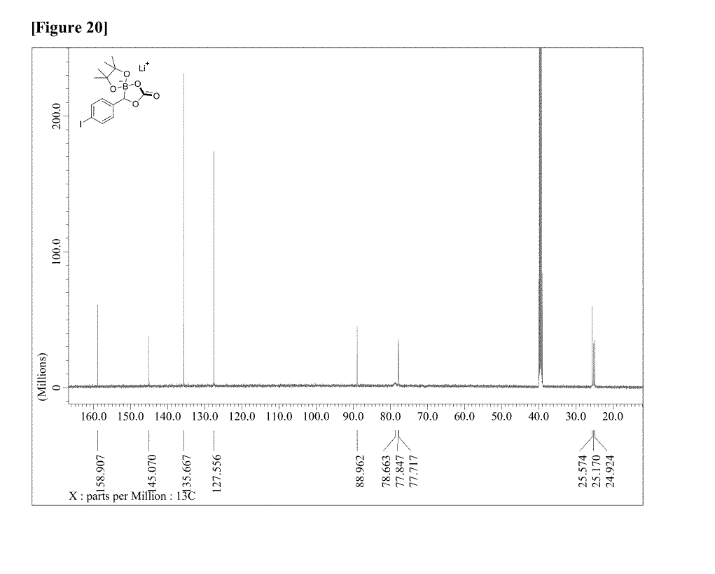

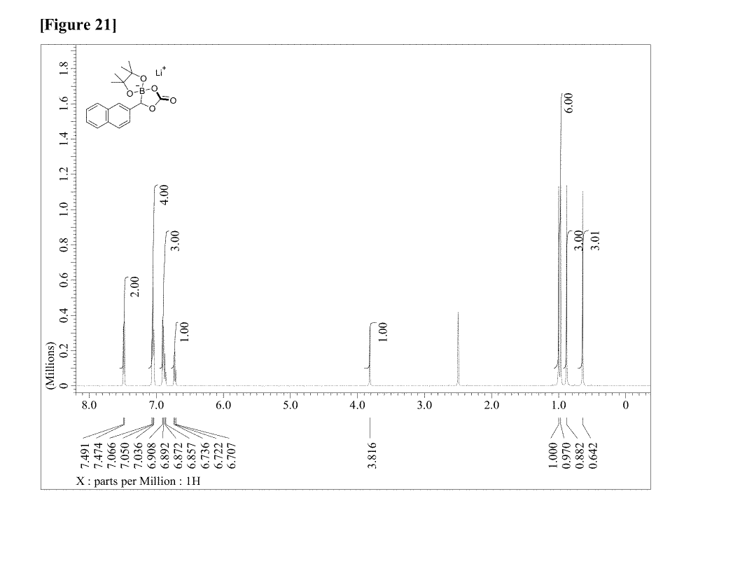

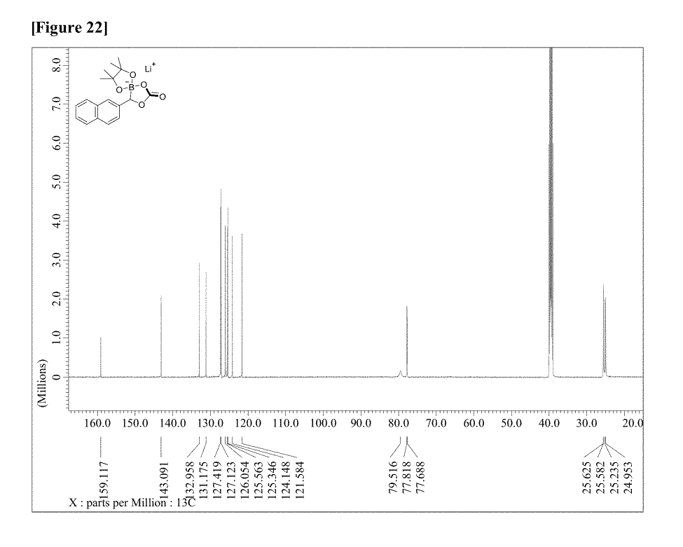

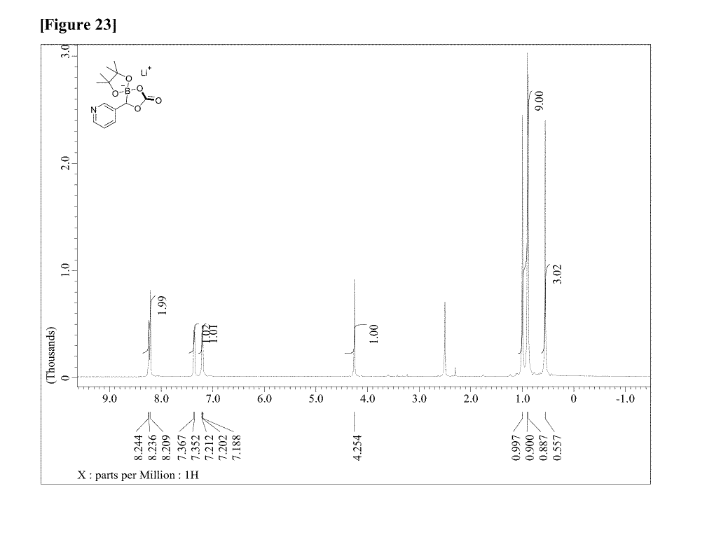

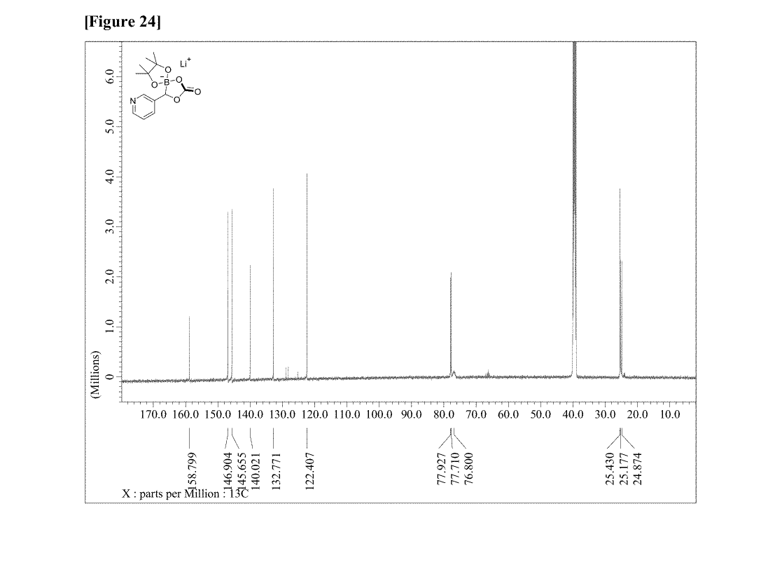

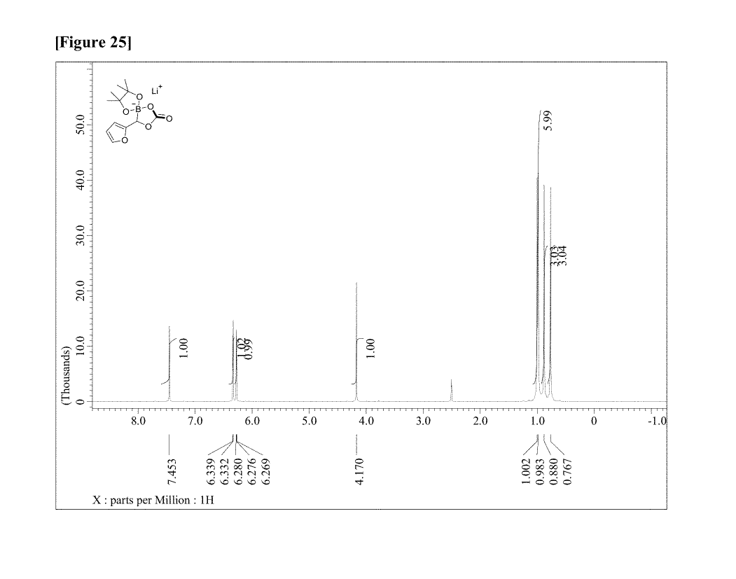

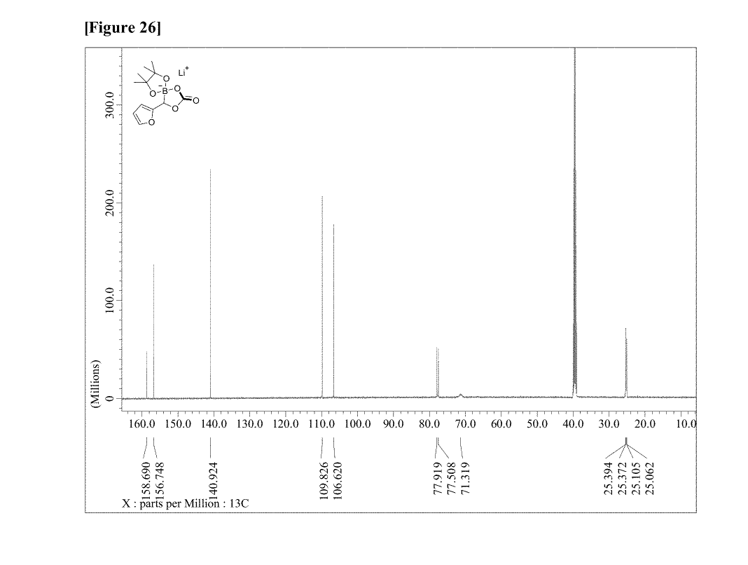

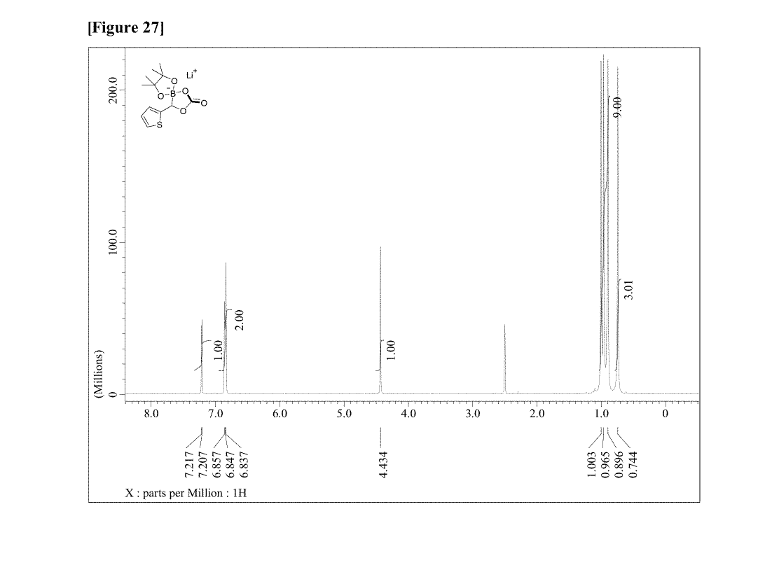

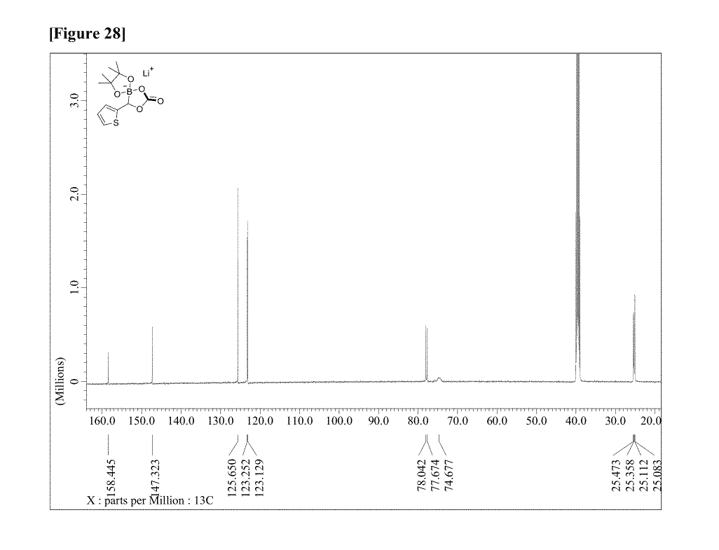

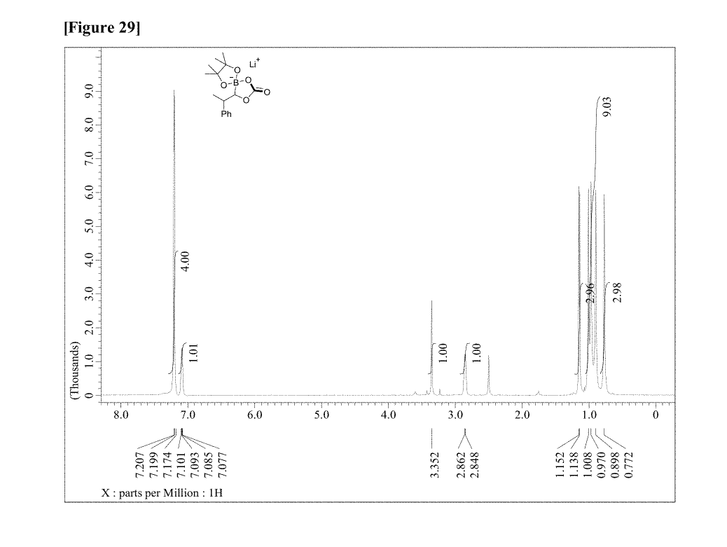

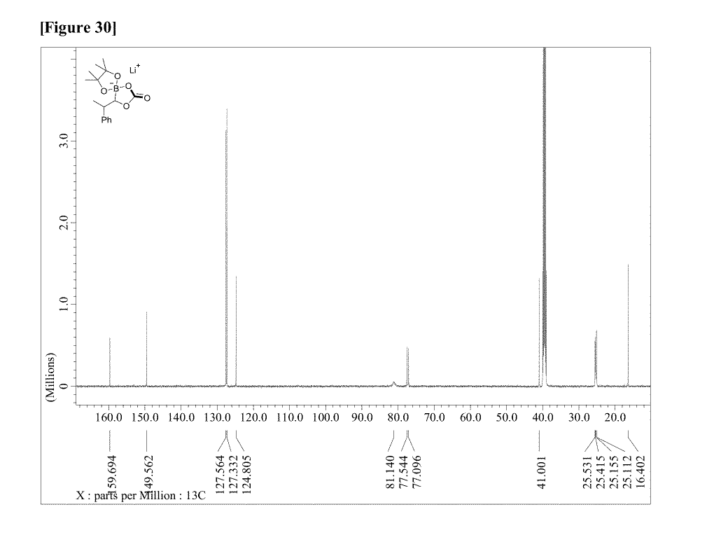

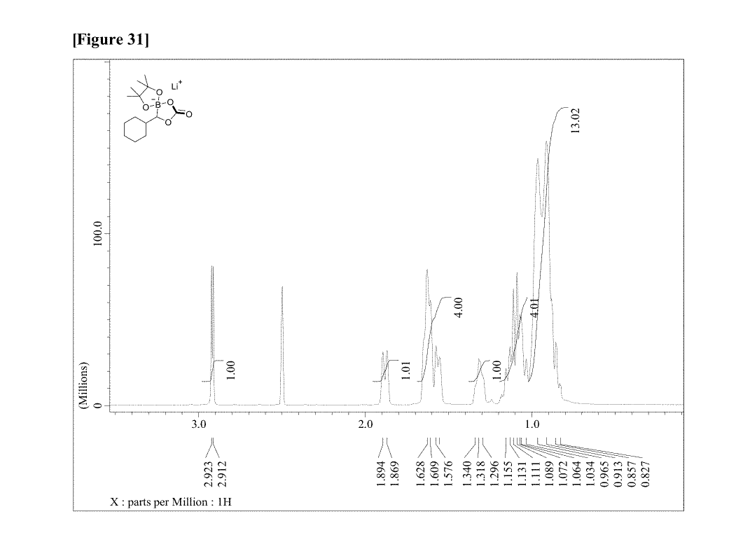

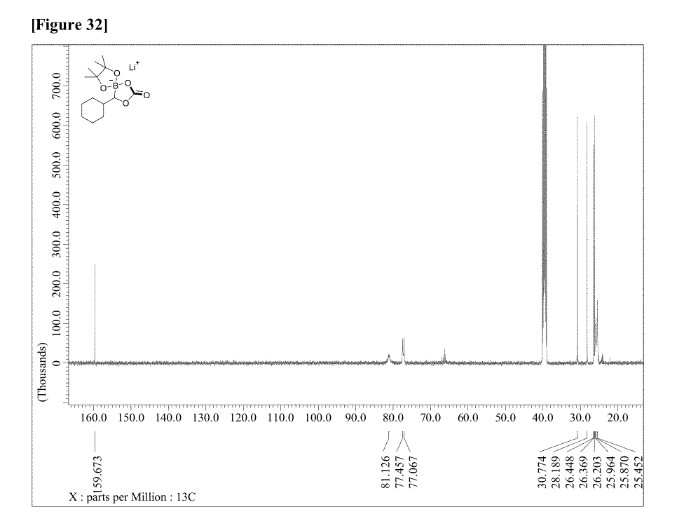

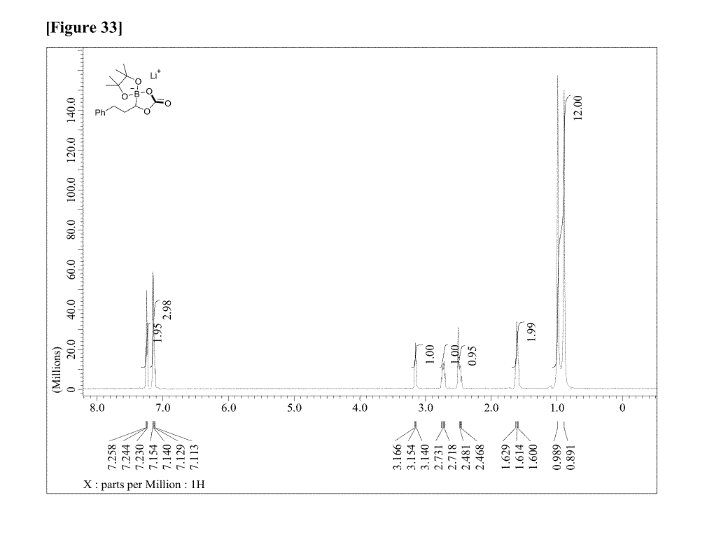

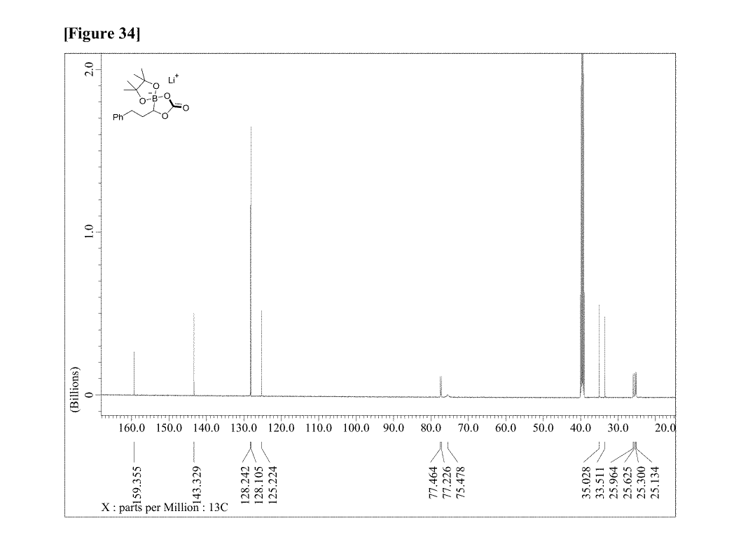

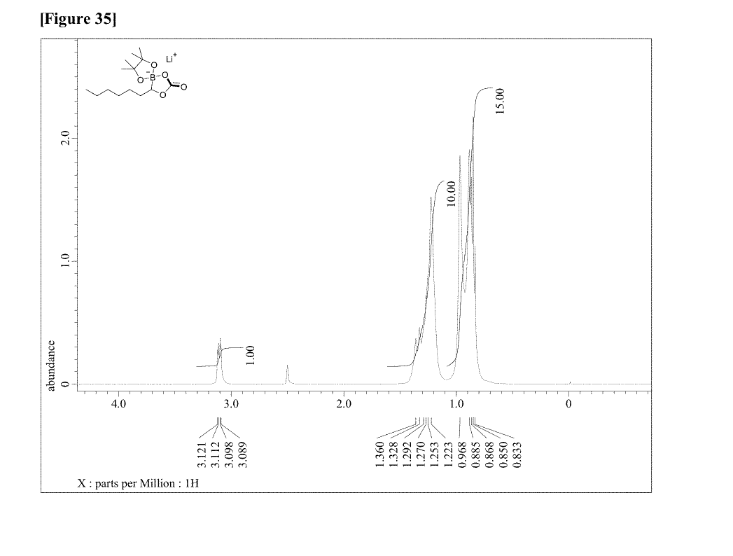

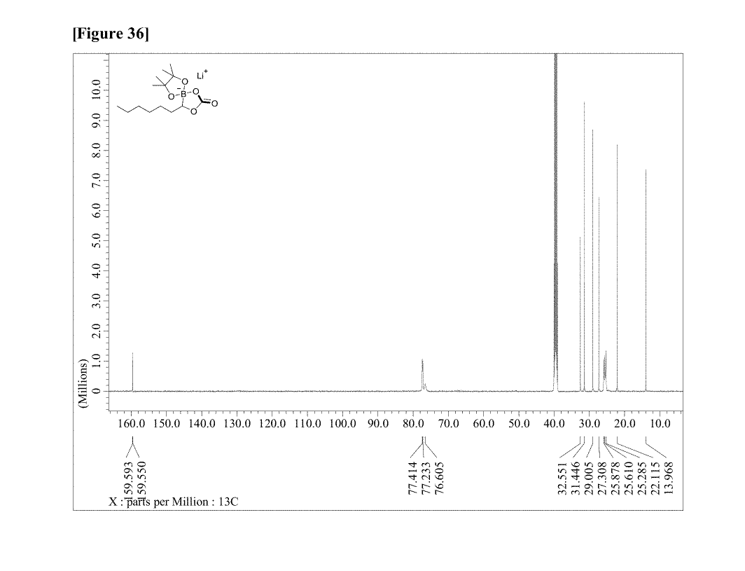

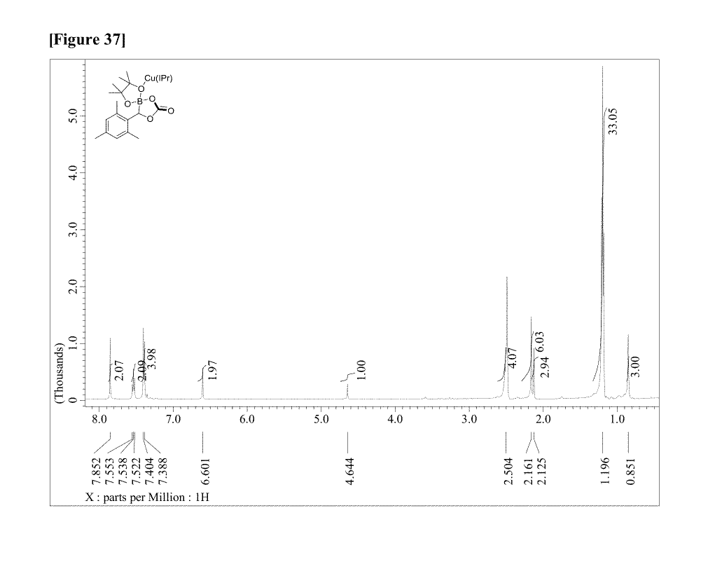

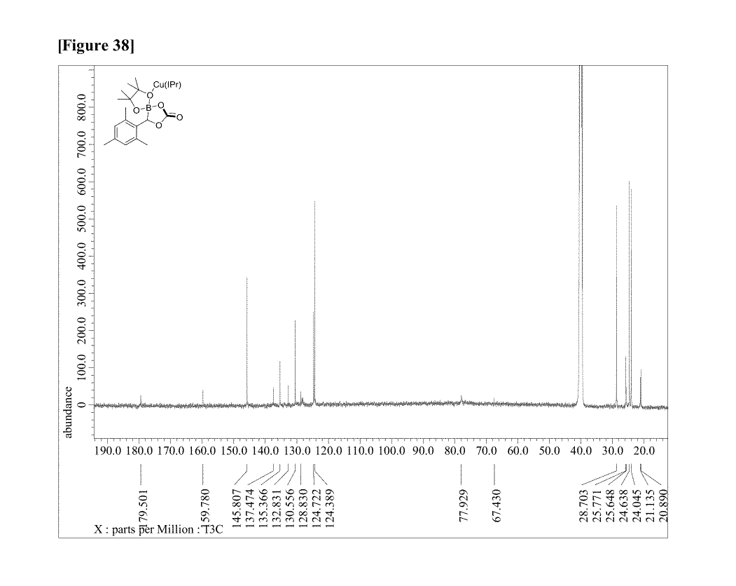

Spectral Data (see FIGS. 1-38 also)
Lithium [5-phenyl-2,4-dioxolan-3-one](pinacolato)borate (2a)

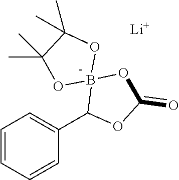

2a was synthesized as a white solid (85% yield) by following the typical experimental procedure.

¹H NMR (400 MHz, DMSO-d₆) δ 0.60 (s, 3H), 0.89 (s, 3H), 0.92 (s, 3H), 1.00 (s, 3H), 4.24 (s, 1H), 6.95-7.23 (m, 5H).

¹³C NMR (125 MHz, DMSO-d₆) δ 159.3, 144.9, 127.0, 125.2, 124.1, 79.5 (br), 77.8, 77.6, 25.5, 25.2, 25.0.

¹¹B NMR (160 MHz, DMSO-d₆) δ 8.8.

HMRS (ESI-TOF) calcd. for C₁₄H₁₈BO₅:277.1255 [M—Li]⁻.

Found: 277.1266.

Anal. Calcd. for C₁₄H₁₈BLiO₅: C, 59.20; H, 6.39. Found: C, 59.34; H, 6.48.

Lithium [5-(2,4,6-trimethylphenyl)-2,4-dioxolan-3-one](pinacolato)borate (2b)

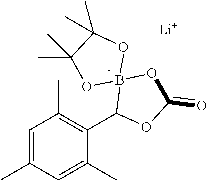

2b was synthesized as a white solid (71% yield) by following the typical experimental procedure.

¹H NMR (500 MHz, DMSO-d₆) δ0.42 (s, 3H), 0.85 (s, 3H), 0.89 (s, 3H), 1.00 (s, 3H), 2.14 (s, 3H), 2.19 (s,6H), 4.68 (s, 1H), 6.62 (s, 2H).

¹³C NMR (125 MHz, DMSO-d₆) δ 159.4, 137.0, 132.4, 128.9, 128.2, 77.7, 77.0, 76.2 (br), 25.3, 25.2, 25.0, 20.6, 20.4.

¹¹B NMR (128 MHz, DMSO-d₆) δ8.9.

HMRS (ESI-TOF) calcd. for C₁₇H₂₄BO₅: 319.1725 [M—Li]⁻. Found: 319.1726.

Anal. Calcd. for C₁₇H₂₄BLiO₅: C, 62.61; H, 7.42. Found: C, 62.49.; H, 7.88.

Lithium [5-(4-methylphenyl)-2,4-dioxolan-3-one](pinacolato)borate (2c)

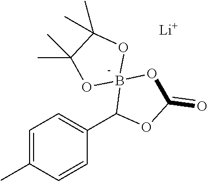

2c was synthesized as a white solid (88% yield) by following the typical experimental procedure.

¹H NMR (500 MHz, DMSO-d₆) δ0.61 (s, 3H), 0.89 (s, 3H), 0.91 (s, 3H), 0.99 (s, 3H), 2.23 (s, 3H), 4.19 (s,1H), 6.88 (d, J=7.0 Hz, 2H), 6.97 (d, J=7.5 Hz, 2H).

¹³C NMR (125 MHz, DMSO-d₆) δ159.3, 141.8, 132.7, 127.6, 125.3, 79.5 (br), 77.7, 77.5, 25.6, 25.2, 25.0, 20.7.

¹¹B NMR (160 MHz, DMSO-d₆) δ8.8.

HMRS (ESI-TOF) calcd. for C₁₅H₂₀BO₅:291.1412 [M—Li]⁻. Found: 291.1426.

Anal. Calcd. for C₁₅H₂₀BLiO₅: C, 60.44; H, 6.76. Found: C, 60.42; H, 6.82.

Lithium [5-(4-methoxyphenyl)-2,4-dioxolan-3-one](pinacolato)borate (2d)

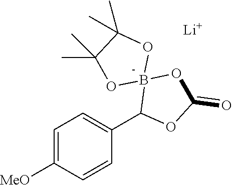

2d was synthesized as a white solid (91% yield) by following the typical experimental procedure.

¹H NMR (500 MHz, DMSO-d₆) δ 0.59 (s, 3H), 0.89 (s, 6H), 0.99 (s, 3H), 3.70 (s, 3H), 4.17 (s, 1H), 6.75 (d, J=8.0 Hz, 2H), 6.95 (d, J=8.5 Hz, 2H).

¹³C NMR (125 MHz, DMSO-d₆) δ159.2, 156.5, 136.7, 126.9, 112.5, 79.4 (br), 77.7, 77.5, 54.3, 25.5, 25.2, 24.9.

¹¹B NMR (128 MHz, DMSO-d₆) 68.8.

HMRS (ESI-TOF) calcd. for C₁₅H₂₀BO₆:307.1361 [M—Li]⁻. Found: 307.1366.

Anal. Calcd. for C₁₅H₂₀BLiO₆: C, 57.36; H, 6.42. Found: C, 57.38; H, 6.55.

Lithium [5-(4-methylthiophenyl)-2,4-dioxolan-3-one](pinacolato)borate (2e)

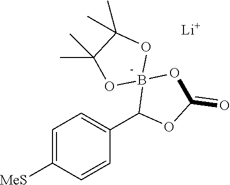

2e was synthesized as a white solid (73% yield) by following the typical experimental procedure.

¹H NMR (500 MHz, DMSO-d₆) δ0.62 (s, 3H), 0.89 (s, 3H), 0.91 (s, 3H), 0.99 (s, 3H), 2.42 (s, 3H), 4.19 (s, 1H), 6.95 (d, J=8.0Hz, 2H), 7.10 (d, J=8.5Hz, 2H).

¹³C NMR (125 MHz, DMSO-d₆) δ 159.0, 142.2, 132.6, 126.0, 125.6, 79.1 (br), 77.8, 77.6, 25.5, 25.2, 24.9, 15.4.

¹¹B NMR (160 MHz, DMSO-d₆) δ 8.8.

HMRS (ESI-TOF) calcd. for C15H₂₀BO₅S:323.1133 [M—Li]⁻. Found: 323.1148.

Anal. Calcd. for C₁₅H₂₀BLiO₅S: C, 54.57; H, 6.11. Found: C, 54.73; H, 6.17.

Lithium [5-(4-trifluoromethylphenyl)-2,4-dioxolan-3-one](pinacolato)borate (2f)

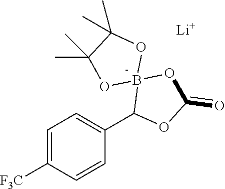

2f was synthesized as a white solid (74% yield) by following the typical experimental procedure.

¹H NMR (400 MHz, DMSO-d₆) δ 0.62 (s, 3H), 0.88 (s, 3H), 0.95 (s, 3H), 1.00 (s, 3H), 4.34 (s, 1H), 7.17 (d, J=8.0 Hz, 2H), 7.53 (d, J=8.4 Hz, 2H).

¹³C NMR (125 MHz, DMSO-d₆) δ 158.8, 150.3, 125.1, 124.8 (q, J=30.6Hz), 124.2 (q, J=269.9 Hz), 123.9 (q, J=3.6 Hz), 78.7 (br), 77.9, 77.8, 25.6, 25.55, 25.2, 24.9.

¹¹B NMR (128 MHz, DMSO-d₆) δ 8.7.

HMRS (ESI-TOF) calcd. for C₁₅H₁₇BF₃O₅:345.1129 [M—Li]⁻. Found: 345.1122.

Anal. Calcd. for C₁₅H₁₇BF₃LiO₅: C, 51.18; H, 4.87. Found: C, 51.18; H, 4.86.

Lithium [5-(4-fluorophenyl)-2,4-dioxolan-3-one](pinacolato)borate (2g)

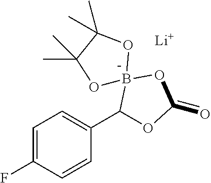

2 g was synthesized as a white solid (86% yield) by following the typical experimental procedure.

¹H NMR (500 MHz, DMSO-d₆) δ0.58 (s, 3H), 0.89 (s, 3H), 0.90 (s, 3H), 0.99 (s, 3H), 4.22 (s, 1H), 6.93-7.06 (m, 4H).

¹³C NMR (125 MHz, DMSO-d₆) δ159.9 (d, J=236.6 Hz), 159.0, 140.9 (d, J=1.9 Hz), 127.0 (d, J=8.1 Hz), 113.6 (d, J=20.8 Hz), 78.8 (br), 77.8, 77.6, 25.5, 25.2, 24.9.

¹¹B NMR (160 MHz, DMSO-d₆) δ8.7.

HMRS (ESI-TOF) calcd. for C₁₄H₁₇BFO₅:295.1161 [M—Li]⁻. Found: 295.1152.

Anal. Calcd. for C₁₄H₁₇BFLiO₅: C, 55.67; H, 5.67. Found: C, 55.89; H 5.58.

Lithium [5-(4-chlorophenyl)-2,4-dioxolan-3-one](pinacolato)borate (2h)

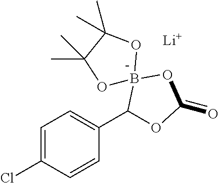

2h was synthesized as a white solid (73% yield) by following the typical experimental procedure.

¹H NMR (400 MHz, DMSO-d₆) δ0.60 (s, 3H), 0.90 (s, 6H), 0.99 (s, 3H), 4.24 (s, 1H), 6.97-7.09 (m, 2H), 7.13-7.26 (m, 2H).

¹³C NMR (125 MHz, DMSO-d₆) δ159.1, 144.1, 128.6, 127.0, 126.9, 78.8 (br), 77.9, 77.8, 25.6, 25.2, 25.0.

¹¹B NMR (160 MHz, DMSO-d₆) δ 8.8.

HMRS (ESI-TOF) calcd. for C₁₄H₁₇BClO₅:311.0866 [M—Li]⁻. Found: 311.0874.

Anal. Calcd. for C₁₄H₁₇BClLiO₅: C, 52.80; H, 5.38. Found: C, 52.85; H, 5.41.

Lithium [5-(4-bromophenyl)-2,4-dioxolan-3-one](pinacolato)borate (2i)

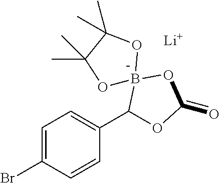

2i was synthesized as a white solid (72% yield) by following the typical experimental procedure.

¹H NMR (500 MHz, DMSO-d₆) δ0.62 (s, 3H), 0.89 (s, 3H), 0.92 (s, 3H), 0.99 (s, 3H), 4.21 (s, 1H), 6.94 (d, J=8.0Hz, 2H), 7.34 (d, J=8.5Hz, 2H).

¹³C NMR (125 MHz, DMSO-d₆) δ158.9, 144.6, 129.8, 127.3, 116.8, 78.7 (br), 77.8, 77.7, 25.5, 25.2, 24.9.

¹¹B NMR (160 MHz, DMSO-d₆) δ8.8.

HMRS (ESI-TOF) calcd. for C₁₄H₁₇BBrO₅: 357.0341 [M—Li]⁻. Found: 357.0344.

Anal. Calcd. for C₁₄H₁₇BBrLiO₅: C, 46.33; H, 4.72. Found: C, 46.33; H, 4.75.

Lithium [5-(4-iodophenyl)-2,4-dioxolan-3-one](pinacolato)borate (2j)

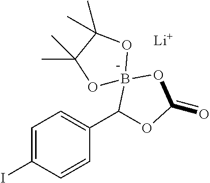

2j was synthesized as a white solid (67% yield) by following the typical experimental procedure.

¹H NMR (500 MHz, DMSO-d₆) δ0.63 (s, 3H), 0.89 (s, 3H), 0.92 (s, 3H), 0.99 (s, 3H), 4.20 (s, 1H), 6.81 (d, J=8.0 Hz, 2H), 7.51 (d, J=8.0 Hz, 2H).

¹³C NMR (125 MHz, DMSO-d₆) δ158.9, 145.1, 135.7, 127.6, 89.0, 78.7 (br), 77.8, 77.7, 25.6, 25.2, 24.9.

¹¹B NMR (128 MHz, DMSO-d₆) δ 8.6.

HMRS (ESI-TOF) calcd. for C₁₄H₁₇BIO₅: 403.0222 [M—Li]⁻. Found: 403.0226.

Anal. Calcd. for C₁₄H₁₇BILiO₅: C, 41.02; H, 4.18. Found: C, 41.19; H, 4.51.

Lithium [5-(2-naphthalenyl)-2,4-dioxolan-3-one](pinacolato)borate (2k)

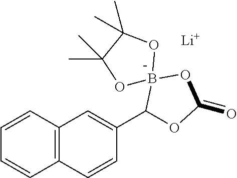

2k was synthesized as a white solid (79% yield) by following the typical experimental procedure.

¹H NMR (500 MHz, DMSO-d₆) δ0.64 (s, 3H), 0.88 (s, 3H), 0.97 (s, 3H), 1.00 (s, 3H), 3.82 (s, 1H), 6.68-6.75 (m, 1H), 6.84-6.91 (m, 3H), 7.02-7.08 (m, 4H), 7.48 (d, J=8.5 Hz, 2H).

¹³C NMR (125 MHz, DMSO-d₆) δ 159.1, 143.1, 133.0, 131.2, 127.4, 127.1, 126.1, 125.6, 125.3, 124.1, 121.6, 79.5 (br), 77.8, 77.7, 25.62, 25.58, 25.2, 25.0.

¹¹B NMR (128 MHz, DMSO-d₆) δ8.9.

HMRS (ESI-TOF) calcd. for C₁₈H₂₀BO₅: 327.1413 [M—Li]⁻. Found: 327.1418.

Anal. Calcd. for C₁₈H₂₀BLiO₅: C, 64.71; H, 6.03. Found: C, 64.91; H, 6.10.

Lithium [5-(3-pyridinyl)-2,4-dioxolan-3-one](pinacolato)borate (21)

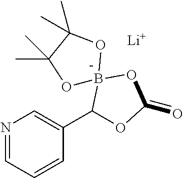

21 was synthesized as a white solid (68% yield) by following the typical experimental procedure.

¹H NMR (500 MHz, DMSO-d₆) δ0.56 (s, 3H), 0.89 (s, 3H), 0.90 (s, 3H), 1.00 (s, 3H), 4.25 (s, 1H), 7.20 (t, J=6.0 Hz, 1H), 7.36 (d, J=7.5 Hz, 1H), 8.21 (s, 1H), 8.24 (d, J=4.0 Hz, 1H).

¹³C NMR (125 MHz, DMSO-d₆) δ158.8, 146.9, 145.7, 140.0, 132.8, 122.4, 77.9, 77.7, 76.8 (br), 25.4, 25.2, 24.9.

¹¹B NMR (128 MHz, DMSO-d₆) δ8.7.

HMRS (ESI-TOF) calcd. for C₁₃H₁₇BNO₅:278.1208 [M—Li]⁻. Found: 278.1212.

Anal. Calcd. for C₁₃H₁₇BLiNO₅: C, 54.78; H, 6.01; N, 4.91.

Found: C, 54.73; H, 6.16; N, 4.87.

Lithium [5-(2-furanyl)-2,4-dioxolan-3-one](pinacolato)borate (2m)

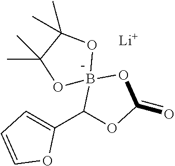

2m was synthesized as a white solid (53% yield) by following the typical experimental procedure.

¹H NMR (500 MHz, DMSO-d₆) δ0.77 (s, 3H), 0.88 (s, 3H), 0.98 (s, 3H), 1.00 (s, 3H), 4.17 (s, 1H), 6.28 (t, J=2.8 Hz, 1H), 6.34 (d, J=3.5 Hz, 1H), 7.45 (s, 1H).

¹³C NMR (125 MHz, DMSO-d₆) δ158.7, 156.7, 140.9, 109.8, 106.6, 77.9, 77.5, 71.3 (br), 25.39, 25.37, 25.11, 25.06.

¹¹B NMR (128 MHz, DMSO-d₆) δ8.4.

HMRS (ESI-TOF) calcd. for C₁₂H₁₆BO₆: 267.1048 [M—Li]⁻. Found: 267.1048.

Anal. Calcd. for C₁₂H₁₆BLiO₆: C, 52.60; H, 5.89. Found: C, 52.56; H, 5.56.

Lithium [5-(2-thienyl)-2,4-dioxolan-3-one](pinacolato)borate (2n)

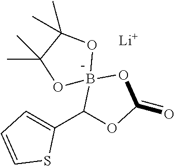

2n was synthesized as a white solid (69% yield) by following the typical experimental procedure.

¹H NMR (500 MHz, DMSO-d₆) δ0.74 (s, 3H), 0.90 (s, 3H), 0.97 (s, 3H), 1.00 (s, 3H), 4.43 (s, 1H), 6.82-6.87 (m, 2H), 7.21 (d, J=5.0 Hz, 1H).

¹³C NMR (125 MHz, DMSO-d₆) δ 158.4, 147.3, 125.7, 123.3, 123.1, 78.0, 77.7, 74.7 (br), 25.5, 25.4, 25.11, 25.08.

¹¹B NMR (128 MHz, DMSO-d₆) δ8.4.

HMRS (ESI-TOF) calcd. for C₁₂H₁₆BO₅S: 283.0819 [M—Li]⁻. Found: 283.0817.

Anal. Calcd. for C₁₂H₁₆BLiO₅S: C, 49.69; H, 5.56. Found: C, 49.33; H, 5.76.

Lithium [5-(1-phenylethyl)-2,4-dioxolan-3-one](pinacolato)borate (2o)

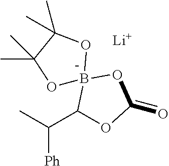

2o was synthesized as a white solid (76% yield) by following the typical experimental procedure.

¹H NMR (500 MHz, DMSO-d₆) δ0.77 (s, 3H), 0.90 (s, 3H), 0.97 (s, 3H), 1.01 (s, 3H). 1.15 (d, J=7.0 Hz, 3H), 2.82-2.88 (m, 1H), 3.35 (s, 1H), 7.06-7.13 (m, 1H), 7.17-7.21 (m, 4H).

¹³C NMR (125 MHz, DMSO-d₆) δ159.7, 149.6, 127.6, 127.3, 124.8, 81.1 (br), 77.5, 77.1, 41.0, 25.5, 25.4, 25.2, 25.1, 16.4.

¹¹B NMR (128 MHz, DMSO-d₆) δ8.7.

HMRS (ESI-TOF) calcd. for C₁₆H₂₂BO₅: 305.1569 [M—Li]⁻. Found: 305.1568.

Anal. Calcd. for C₁₆H₂₂BLiO₅: C, 61.58; H, 7.11. Found: C, 61.48; H, 7.49.

Lithium [5-cyclohexyl-2,4-dioxolan-3-one](pinacolato)borate (2p)

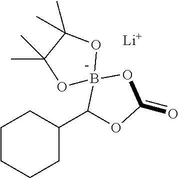

2p was synthesized as a white solid (77% yield) by following the typical experimental procedure. ¹H NMR (500 MHz, DMSO-d₆) δ 0.83-0.98 (m, 13H), 1.02-1.17 (m, 4H), 1.27-1.36 (m, 1H), 1.51-1.69 (m, 4H), 1.86-1.90 (m, 1H), 2.92 (d, J=5.5 Hz, 1H).

¹³C NMR (125 MHz, DMSO-d₆) δ159.7, 81.1 (br), 77.5, 77.1, 30.8, 28.2, 26.45, 26.37, 26.2, 26.0, 25.9, 25.5.

¹¹B NMR (128 MHz, DMSO-d₆) 68.8.

HMRS (ESI-TOF) calcd. for C₁₄H₂₄BO₅: 283.1725 [M—Li]⁻. Found: 283.1729.

Anal. Calcd. for C₁₄H₂₄BLiO₅: C, 57.97; H, 8.34. Found: C, 57.96: H, 8.16.

Lithium [5-(2-phenylethyl)-2,4-dioxolan-3-one](pinacolato)borate (2q)

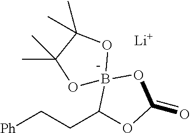

2q was synthesized as a white solid (82% yield) by following the typical experimental procedure.

¹H NMR (500 MHz, DMSO-d₆) δ0.89 (s, 6H), 0.99 (s, 6H), 1.57-1.63 (m, 2H), 2.45-2.50 (m, 1H), 2.69-2.77 (m, 1H), 3.15 (t, J=6.5 Hz, 1H), 7.10-7.16 (m, 3H), 7.24 (t, J=7.0 Hz, 2H).

¹³C NMR (125 MHz, DMSO-d₆) δ159.4, 143.3, 128.2, 128.1, 125.2, 77.5, 77.2, 75.5 (br), 35.0, 33.5, 26.0, 25.6, 25.3, 25.1.

¹¹B NMR (128 MHz, DMSO-d₆) δ8.7.

HMRS (ESI-TOF) calcd. for C₁₆H₂₂BO₅: 305.1569 [M—Li]⁻. Found: 305.1571.

Anal. Calcd. for C₁₆H₂₂BLiO₅: C, 61.58; H, 7.11. Found: C, 61.21; H, 7.46.

Lithium [5-hexyl-2,4-dioxolan-3-one](pinacolato)borate (2r)

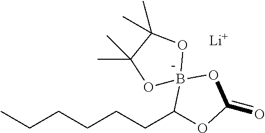

2r was synthesized as a white solid (60% yield) by following the typical experimental procedure.

¹H NMR (500 MHz, DMSO-d₆) δ 0.81-0.97 (m, 15H), 1.18-1.39 (m, 10H), 3.11 (dd, J=11.5, 4.5 Hz, 1H).

¹³C NMR (125 MHz, DMSO-d₆) δ159.6, 77.4, 77.2, 76.6 (br), 32.6, 31.4, 29.0, 27.3, 25.9, 25.6, 25.3, 22.1, 14.0.

¹¹B NMR (128 MHz, DMSO-d₆) δ8.9.

HMRS (ESI-TOF) calcd. for C₁₄H₂₆BO₅:285.1881 [M—Li]⁻.

Found: 285.1881.

Anal. Calcd. for C₁₄H₂₆BLiO₅: C, 57.57; H, 8.97. Found: C, 57.45; H, 8.83.

### Complex 3

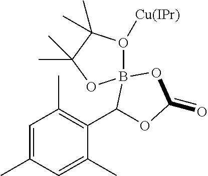

3 was synthesized as a white solid (78% yield).

¹H NMR (500 MHz, DMSO-d₆) δ0.85 (s, 3H), 1.10-1.22 (m, 33H), 2.13 (s, 3H), 2.16 (s, 6H), 2.51 (br, 4H), 4.64 (s, 1H), 6.60 (s, 2H), 7.38-7.40 (m, 4H), 7.54 (t, J=7.8Hz, 2H), 7.85 (s, 2H).

¹³C NMR (125 MHz, DMSO-d₆) δ179.5, 159.8, 145.8, 137.5, 135.4, 132.9, 130.6, 128.8, 124.7, 124.4, 124.3, 77.9, 67.4, 28.7, 25.8, 25.6, 24.6, 24.0, 21.1, 20.9.

¹¹B NMR (128 MHz, DMSO-d₆) δ23.3.

Anal. Calcd. for C₄₄H60BCuN₂O₅: C, 68.52; H, 7.84; N, 3.63. Found: C, 68.30; H, 7.80; N, 3.74.

### X-Ray Data

A crystal was sealed in a thin-walled glass capillary under a microscope in the glove box. X-ray diffraction data collections were performed on a Bruker D8 QUEST diffractometer equipped with a CMOS area detector, using a IμS (Incoatec Microfocus Source) microfocus sealed tube with Mo Kα radiation (λ=0.71073 Å) at 173 K. The Bravais lattice and the unit cell parameters were determined by the Bruker APEX2³ software package. The raw frame data were processed, and absorption corrections were done using SAINT and SADABS embedded in Bruker APEX2 to yield the reflection data (hkl) file. All of the structures were solved using SHELXS-97⁴. Structural refinement was performed using the SHELXL-97 option in the WINGX system⁵, on F² anisotropically for all of the non-hydrogen atoms by the fullmatrix least-squares method. Analytical scattering factors for neutral atoms were used throughout the analysis.

The structures were solved by using SHELXTL program. Refinements were performed on F² anisotropically for non-hydrogen atoms by the full-matrix least-squares method. The analytical scattering factors for neutral atoms were used throughout the analysis. The hydrogen atoms were placed at the calculated positions and were included in the structure calculation without further refinement of the parameters. The residual electron densities were of no chemical significance. CCDC number 1453331 contains the supplementary crystallographic data for this paper. This data can be obtained free of charge from The Cambridge Crystallographic Data Centre via www.ccdc.cam.ac.uk/data_request/cif.

X-ray Data for Complex 2a′

ORTEP drawing of 2a′. Thermal ellipsoids set at 30% probability. Hydrogen atoms have been omitted for clarity.

Crystal Data and Structure Refinement for 2a′

| Identification code | Lithium | |
|---|---|---|
| | phenyldioxolanone(pinacolato)borate | |
| Empirical formula | C36 H56 B2 Li2 | |
| Formula weight | O14 | |
| Temperature | 748.31 | |
| Wavelength | 173(2) K | |
| Crystal system | 0.71073 Å | |
| Space group | Monoclinic | |
| Unit cell | P 21/c | α = 90° |
| dimensions | a = 15.125(3) Å | β = 112.453(11)° |
| | b = 10.132(2) Å | γ = 90° |
| | c = 14.654(3) Å | |
| Volume | 2075.5(8) Å³ | |
| Z | 2 | |
| Calculated density | 1.197 Mg/m³ | |
| Absorption | 0.089 mm⁻¹ | |
| coefficient | 800 | |
| F(000) | 0.20 x 0.20 x 0.10 | |
| Crystal size | mm³ | |
| Theta range for | 2.00 to 25.00°. | |
| data collection | −18 <= h <= 17, | |
| Limiting indices | −12 <= k <= 12, | |
| | −17 <= l <= 17 | |
| | 34127/3608 | |
| Reflections | [R(int) = 0.1102] | |
| collected/unique | 98.2% | |
| Completeness to | Empirical | |
| theta = 25.00 | 0.9825 and 0.9912 | |
| Absorption | Full-matrix least- | |
| correction | squares on F² | |
| Max. and min. | 3608/0/250 | |
| transmission | 1.016 | |
| Refinement method | R1 = 0.0751, wR2 = | |
| Data/restraints/ | 0.1131 | |
| parameters | R1 = 0.1571, wR2 = | |
| Goodness-of-fit on | 0.1375 | |
| F₂ | 0.332 and −0.241 | |
| Final R indices | e.A⁻³ | |
| [I > 2sigma(I)] | | |
| R indices (all data) | | |
| Largest diff. peak | | |
| and hole | | |

### REFERENCES

(1) Citadelle, C. A.; Nouy, E. L.; Bisaro, F.; Slawin, A. M. Z.; Cazin, C. S. J. Dalton Trans. 2010, 39 (19), 4489-4491.
(2) Mankad, N. P.; Laitar, D. S.; Sadighi, J. P. Organometallics 2004, 23 (14), 3369-3371.
(3) APEX2 v2013.2-0; Bruker AXS Inc., Madison, Wisc., 2007.
(4) Sheldrick, G. M. Acta Crystallogr., Sect. A 2008, A64, 112-122.
(5) Farrugia, L. J. J. Appl. Crystallogr. 1999, 32, 837-838.

### Example 2

### Typical Procedure for the Boracarboxylation of N-Benzylidenaniline

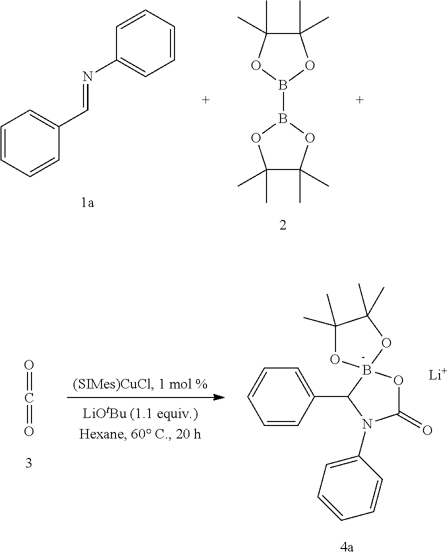

In a glovebox, [(SIMes)CuCl] (1 mol %, 4.1 mg), B₂pin₂ (1 mmol, 253.9 mg), N-benzylidenaniline (1.0 mmol, 181.2 mg), LiO^{t}Bu (1.1 equiv, 88.0 mg), and Hexane (5 mL) were added into a 50-mL Schlenk tube equipped with a magnetic stirring bar and a Teflon cap. After the solution was stirred at room temperature for 5 min, the sealed reaction tube was taken out of the glovebox. The reaction mixture was subjected to vacuum for a while, CO₂ (1 atm) was then introduced into the reaction tube. The sealed Schlenk tube was stirred in an oil bath at 60° C. for 20 h. After the reaction mixture was cooled to room temperature, the autoclave was taken back into the glovebox and the solvent was removed under reduced pressure. The residue was dissolved in 10 mL of THF and filtrated with a sintered disc filter funnel (P16) and the clear filtrate was concentrated under vacuum. The product was then purified by recrystallization from its THF/hexane solution at −30 ° C. The desired product 4a was obtained after removal of the coordinated THF solvent molecule under vacuum at 70° C. for 3 days as an off-white solid (323.5 mg, 90% yield).

Lithium 7,7,8,8-tetramethyl-2-oxo-3,4-diphenyl-1,6,9-trioxa-3-aza-5-boraspiro[4.4]nonan-5-uide (4a)

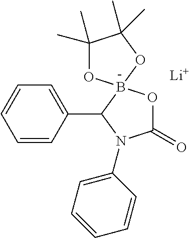

Off-white Solid, Yield 90%. ¹H NMR (500 MHz, DMSO-d₆) δ 7.48 (d, J=8.0 Hz, 2H), 7.05 (t, J=7.3 Hz, 3H), 6.91-6.86 (m, 3H), 6.73 (t, J=7.3 Hz, 1H), 3.83 (s, 1H), 1.00 (s, 3H), 0.97 (s, 3H), 0.89 (s, 3H), 0.64 (s, 3H). ¹³C NMR (125 MHz, DMSO-d₆) δ 159.9, 146.7, 143.1, 128.1, 127.5, 126.2, 123.6, 120.5, 120.1, 78.1, 78.0, 59.1, 26.2, 26.1, 25.9, 25.6. ¹¹B NMR (128 MHz, DMSO-d₆) δ 8.0. Anal. Calcd. for C₂₀H₂₃BLiNO_{4:} C, 66.88; H, 6.46; N 3.90. Found: C, 67.24; H, 6.54; N, 4.12.

Lithium 4-(4-fluorophenyl)-7,7,8,8-tetramethyl-2-oxo-3-phenyl-1,6,9-trioxa-3-aza-5-boraspiro[4.4]nonan-5-uide

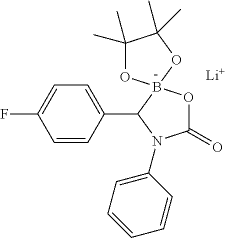

Offwhite Solid, Yield 93%. ¹H NMR (500 MHz, DMSO-d₆) δ 7.46 (d, J=8.0 Hz, 2H), 7.06 (t, J=8.0 Hz, 2H), 6.91-6.85 (m, 3H), 6.73 (t, J=7.3 Hz, 1H), 3.84 (s, 1H), 1.00 (s, 3H), 0.95 (s, 3H), 0.89 (s, 3H), 0.62 (s, 3H). ¹³C NMR (125 MHz, DMSO-d₆) δ 160.6, 159.7, 158.8, 142.9, 142.6, 142.5, 128.1, 127.7, 127.6, 120.7, 120.3, 114.1, 114.0, 78.1, 78.00, 58.2, 26.2, 26.1, 25.9, 25.6. ¹¹B NMR (128 MHz, DMSO-d₆) δ 7.8. ¹⁹F NMR (376 MHz, DMSO-d₆) δ −121.1.

Lithium 4-(4-chlorophenyl)-7,7,8,8-tetramethyl-2-oxo-3-phenyl-1,6,9-trioxa-3-aza-5-boraspiro[4.4]nonan-5-uide

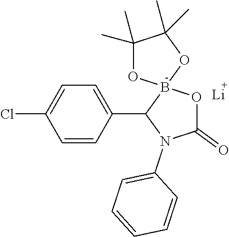

White Solid, Yield 94%. ¹H NMR (500 MHz, DMSO-d₆) δ 7.46 (d, J=8.1 Hz, 2H), 7.11-7.06 (m, 4H), 6.91 (d, J=8.3 Hz, 2H), 6.75 (t, J=7.3 Hz, 1H), 3.85 (s, 1H), 1.01 (s, 3H), 0.97 (s, 3H), 0.90 (s, 3H), 0.64 (s, 3H). ¹³C NMR (125 MHz, DMSO-d₆) δ 159.7, 145.9, 142.9, 128.2, 127.9, 127.9, 127.5, 120.8, 120.2, 78.1, 78.1, 58.4, 26.2, 26.1, 25.9, 25.6. ¹B NMR (128 MHz, DMSO-d₆) δ 7.5.

Lithium 4-(4-bromophenyl)-7,7,8,8-tetramethyl-2-oxo-3-phenyl-1,6,9-trioxa-3-aza-5-boraspiro[4.4]nonan-5-uide

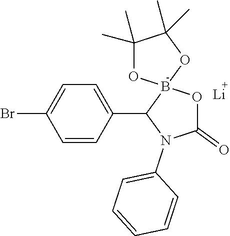

White Solid, Yield 90%. ¹H NMR (500 MHz, DMSO-d₆) δ 7.46 (d, J=8.0 Hz, 2H), 7.23 (d, J=8.3 Hz, 2H), 7.07 (t, J=7.9 Hz, 2H), 6.85 (d, J=8.3 Hz, 2H), 6.75 (t, J=7.3 Hz, 1H), 3.83 (s, 1H), 1.01 (s, 3H), 0.97 (s, 3H), 0.90 (s, 3H), 0.65 (s, 3H). ¹³C NMR (125 MHz, DMSO-d₆) δ 159.7, 146.4, 142.8, 130.3, 128.4, 128.2, 120.8, 120.2, 116.2, 78.1, 78.1, 58.4, 26.2, 26.1, 25.9, 25.6. ¹¹B NMR (128 MHz, DMSO-d₆) δ 7.6.

Lithium 4-(4-(dimethylamino)phenyl)-7,7,8,8-tetramethyl-2-oxo-3-phenyl-1,6,9-trioxa-3-aza-5-boraspiro[4.4]nonan-5-uide

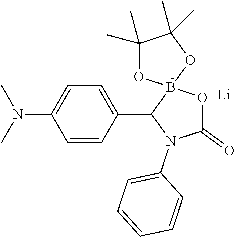

White Solid, Yield 91%. ¹H NMR (500 MHz, DMSO-d₆) δ 7.49 (d, J=8.3 Hz, 2H), 7.04 (t, J=7.6 Hz, 2H), 6.74 (d, J=8.0 Hz, 2H), 6.71 (t, J=7.3 Hz, 1H), 6.50 (d, J=8.2 Hz, 2H), 3.70 (s, 1H), 2.76 (s, 6H), 1.00 (s, 3H), 0.96 (s, 3H), 0.90 (s, 3H), 0.67 (s, 3H).). ¹³C NMR (125 MHz, DMSO-d₆) δ 160.0, 147.7, 143.4, 134.8, 128.0, 126.9, 120.3, 120.1, 112.8, 78.0, 77.9, 58.4, 41.2, 26.2, 26.1, 25.9, 25.7. ¹¹B NMR (128 MHz, DMSO-d₆) δ 7.9.

Lithium 7,7,8,8-tetramethyl-2-oxo-3-phenyl-4-(4-(trifluoromethyl)phenyl)-1,6,9-trioxa-3-aza-5-boraspiro[4.4]nonan-5-uide

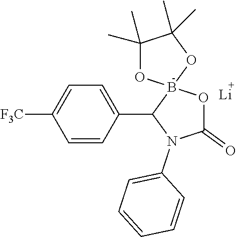

White Solid, Yield 76%. ¹H NMR (500 MHz, DMSO-d₆) δ 7.48 (d, J=8.1 Hz, 2H), 7.42 (d, J=7.9 Hz, 2H), 7.10-7.07 (m, 4H), 6.76 (t, J=7.2 Hz, 1H), 3.97 (s, 1H), 1.02 (s, 3H), 0.99 (s, 3H), 0.89 (s, 3H), 0.64 (s, 3H). ¹³C NMR (125 MHz, DMSO-d₆) δ 159.6, 152.2, 142.8, 128.3, 126.5, 124.5, 124.5, 124.4, 124.4, 124.3, 124.2, 120.9, 120.0, 78.2(2), 59.02, 26.2, 26.1, 25.9, 25.6. ¹¹B NMR (128 MHz, DMSO-d₆) δ 7.6. ¹⁹F NMR (376 MHz, DMSO-d₆) δ −59.97.

Lithium 4-(4-methoxyphenyl)-7,7,8,8-tetramethyl-2-oxo-3-phenyl-1,6,9-trioxa-3-aza-5-boraspiro[4.4]nonan-5-uide

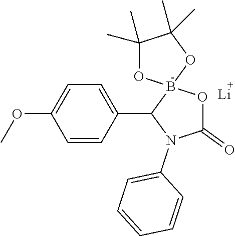

White Solid, Yield 85%. ¹H NMR (500 MHz, DMSO-d₆) δ 7.48 (d, J=7.5 Hz, 2H), 7.05 (t, J=6.7 Hz, 2H), 6.81 (d, J=7.8 Hz, 2H), 6.73 (t, J=6.1 Hz, 1H), 6.64 (d, J=7.9 Hz, 2H), 3.76 (s, 1H), 3.63 (s, 3H), 1.00 (s, 3H), 0.96 (s, 3H), 0.89 (s, 3H), 0.64 (s, 3H). ¹³C NMR (125 MHz, DMSO-d₆) δ 159.9, 156.2, 143.2, 138.5, 128.1, 127.2, 120.5, 120.2, 113.1, 78.0, 77.9, 58.3, 55.1, 26.2, 26.1, 25.9, 25.6. ¹¹ B NMR (128 MHz, DMSO-d₆) δ 8.1.

Lithium 7,7,8,8-tetramethyl-2-oxo-4-(perfluorophenyl)-3-phenyl-1,6,9-trioxa-3-aza-5-boraspiro[4.4]nonan-5-uide

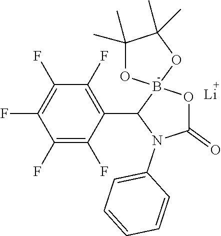

White Solid, Yield 76%. ¹NMR (500 MHz, DMSO-d₆) δ 7.44 (d, J=8.1 Hz, 2H), 7.15 (t, J=7.9 Hz, 2H), 6.83 (t, J=7.3 Hz, 1H), 4.25 (s, 1H), 1.03 (s, 3H), 0.92 (s, 6H), 0.57 (s, 3H). ¹³C NMR (125 MHz, DMSO-d₆) δ 158.9, 146.0, 144.8, 144.0, 142.9, 142.4, 138.2, 137.7, 137.0, 136.2, 136.0, 136.0, 135.6, 135.4, 128.6, 121.6, 120.8, 120.7, 120.6, 119.8, 78.4, 78.2, 48.7, 25.9, 25.6, 25.5, 25.3. ¹¹ NMR (128 MHz, DMSO-d₆) δ 7.1.

Lithium 4-(4-iodophenyl)-7,7,8,8-tetramethyl-2-oxo-3-phenyl-1,6,9-trioxa-3-aza-5-boraspiro[4.4]nonan-5-uide

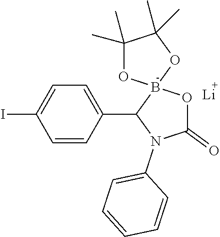

White Solid, Yield 78%. ¹H NMR (500 MHz, DMSO-d₆) δ 7.46 (d, J=8.0 Hz, 2H), 7.39 (d, J=8.2 Hz, 2H), 7.07 (t, J=7.9 Hz, 2H), 6.77-6.72 (m, 3H), 3.80 (s, 1H), 1.00 (s, 3H), 0.97 (s, 3H), 0.90 (s, 3H), 0.66 (s, 3H). ¹³C NMR (125 MHz, DMSO-d₆) δ 159.6, 146.9, 142.9, 136.2, 128.8, 128.2, 120.7, 120.1, 88.3, 78.1(2), 58.6, 26.2, 26.1, 25.9, 25.6. ¹¹B NMR (128 MHz, DMSO-d₆) δ 7.9.

Lithium 3-(4-fluorophenyl)-7,7,8,8-tetramethyl-2-oxo-4-phenyl-1,6,9-trioxa-3-aza-5-boraspiro[4.4]nonan-5-uide

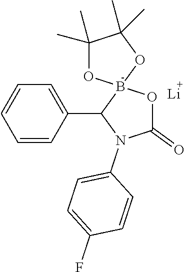

White Solid, Yield 82%. ¹H NMR (500 MHz, DMSO-d₆) δ 7.52-7.43 (m, 2H), 7.06 (t, J=7.6 Hz, 2H), 6.90-6.87 (m, 5H), 3.82 (s, 1H), 1.01 (s, 3H), 0.97 (s, 3H), 0.89 (s, 3H), 0.63 (s, 3H). ¹³C NMR (125 MHz, DMSO-d₆) δ 159.9, 157.8, 155.9, 146.3, 139.5(2), 127.6, 126.3, 123.8, 121.6, 121.5, 114.6, 114.4, 78.1, 78.0, 59.3, 26.2, 26.1, 25.9, 25.6. ¹¹B NMR (128 MHz, DMSO-d₆) δ 7.7. ¹⁹F NMR (376 MHz, DMSO-d₆) δ-123.7.

Lithium 7,7,8,8-tetramethyl-2-oxo-4-phenyl-3-(4-(trifluoromethyl)phenyl)-1,6,9-trioxa-3-aza-5-boraspiro[4.4]nonan-5-uide

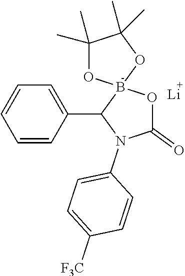

White Solid, Yield 87%. ¹H NMR (500 MHz, DMSO-d₆) δ 7.71 (d, J=8.1 Hz, 1H), 7.40 (d, J=8.1 Hz, 1H), 7.08 (t, J=6.8 Hz, 1H), 6.90 (t, J=7.0 Hz, 1H), 3.86 (s, 1H), 1.01 (s, 3H), 0.99 (s, 3H), 0.90 (s, 3H), 0.68 (s, 3H).). ¹³C NMR (125 MHz, DMSO-d₆) δ 159.4, 146.6, 145.8, 128.5, 127.8, 126.3, 126.0, 125.4 (2), 125.3, 124.2, 123.9, 120.7, 120.5, 120.2, 120.0, 119.3, 78.2(2), 59.0, 26.1(2), 25.9, 25.6. ¹¹HB NMR (128 MHz, DMSO-d₆) δ 7.7.

Lithium 3-(4-iodophenyl)-7,7,8,8-tetramethyl-2-oxo-4-phenyl-1,6,9-trioxa-3-aza-5-boraspiro[4.4]nonan-5-uide

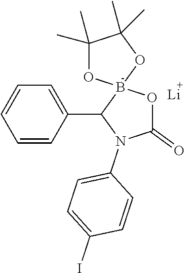

White Solid, Yield 89%. ¹H NMR (500 MHz, DMSO-d₆) δ 7.38-7.26 (m, 4H), 7.07 (t, J=7.6 Hz, 2H), 6.91-6.87 (m, 3H), 3.78 (s, 1H), 1.00 (s, 3H), 0.97 (s, 3H), 0.88 (s, 3H), 0.65 (s, 3H). ¹³C NMR (125 MHz, DMSO-d₆) δ 159.5, 146.1, 143.0, 136.7, 127.6, 126.1, 123.8, 122.4, 83.6, 78.1(2), 58.8, 26.2, 26.1, 25.9, 25.6. ¹¹B NMR (128 MHz, DMSO-d₆) δ 7.7.

Lithium 7,7,8,8-tetramethyl-2-oxo-3-phenyl-4-(p-tolyl)-1,6,9-trioxa-3-aza-5-boraspiro[4.4]nonan-5-uide

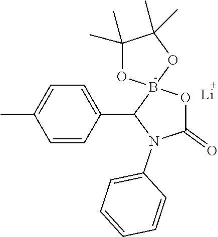

White Solid, Yield 86%. ¹H NMR (500 MHz, DMSO-d₆) δ 7.48 (d, J=8.0 Hz, 2H), 7.04 (t, J=7.6 Hz, 2H), 6.86 (d, J=7.5 Hz, 2H), 6.78 (d, J=7.6 Hz, 2H), 6.72 (t, J=7.0 Hz, 1H), 3.77 (s, 1H), 2.16 (s, 3H), 1.00 (s, 3H), 0.97 (s, 3H), 0.89 (s, 3H), 0.66 (s, 3H). ¹³C NMR (125 MHz, DMSO-d₆) δ 159.9, 143.5, 143.2, 132.0, 128.2, 128.1, 126.1, 120.4, 120.0, 78.0, 77.9, 58.8, 26.2, 26.1, 25.9, 25.6, 21.1. ¹¹B NMR (128 MHz, DMSO-d₆) δ 7.3.

### Example 3

Thermogravimetric Analysis (TGA) was performed using a Q50 thermal analyzer (TA instruments). Samples (ca. 6 mg) were heated from room temperature up to 500° C. at a rate of 10° C./min under flowing N₂ gas (50 mL/min).

For the measurements of ionic conductivity as a function of temperature, custom-made symmetric cells were prepared having the following configuration: (SS|GF/C|SS). The stainless steel (SS) and GF/C separator (glass microfiber filter, Whatman, ϕ=26 mm) electrodes had a surface area of 3.14 cm² and 5.31 cm² respectively. The volume of the electrolyte put on the separator was 100 μL. The assembly of the cell was conducted in and Argon filled glovebox. Electrochemical impedance spectroscopy (EIS) was performed on a VMP3 potentiostat (Biologic) and analyzed by the EC-Lab V10.21 software package. Nyquist plots were obtained at a frequency range from 0.8 MHz to 100 MHz at an AC amplitude of 10 mV. The symmetric cells were placed inside a constant-temperature container (Isuzu VTEC-18) where the temperature was increased from room temperature to 100° C. in 10° C. increments (heating rate: 1° C./min).

For the lithium symmetric cells, the configuration was as follows: (SS|Li|electrolyte|GF/C|electrolyte|SS). The lithium metal (Honjo metal) was rolled on the stainless steel surface (1.57 cm²) in order to be become thin and flat. The volume of electrolyte added each time was 80 μL (giving a total volume of 160 μL). The assembly of the cell was conducted in and Argon filled glovebox. EIS was performed on a VMP3 potentiostat (Biologic) and analyzed by the EC-Lab V10.21 software package. Nyquist plots were obtained at a frequency range from 0.7 MHz to 200 MHz at an AC amplitude of 10 mV. The Li symmetric cells were placed inside a constant-temperature container (Isuzu VTEC-18) where the temperature was increased from room temperature to 100° C. in 10° C. increments (heating rate: 1° C./min).

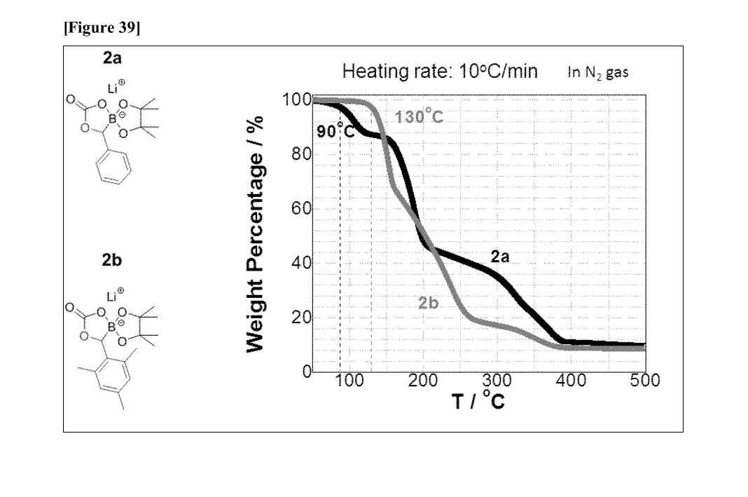

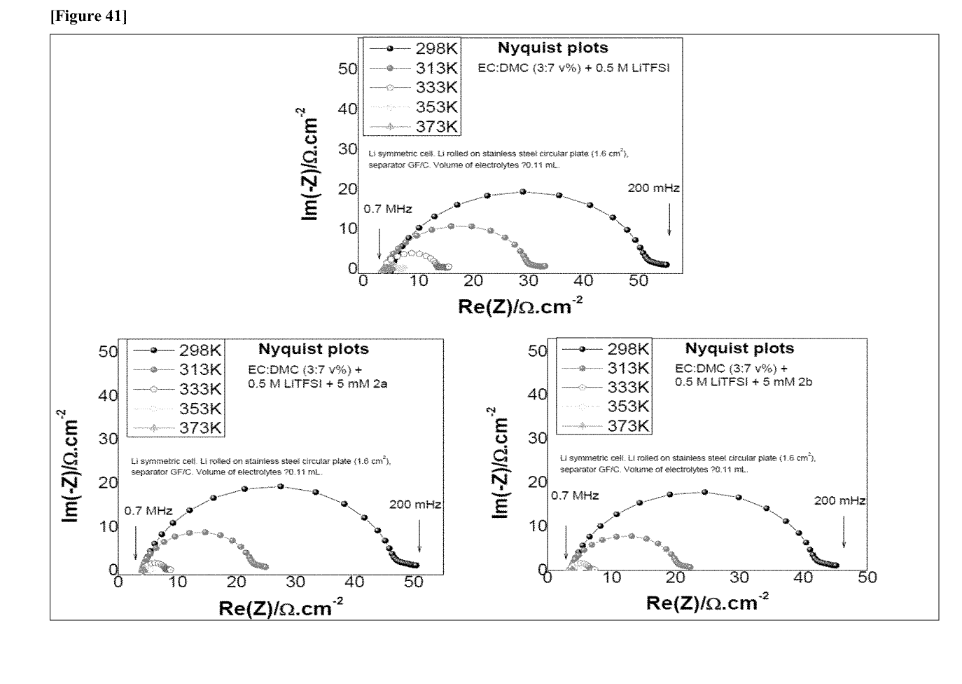

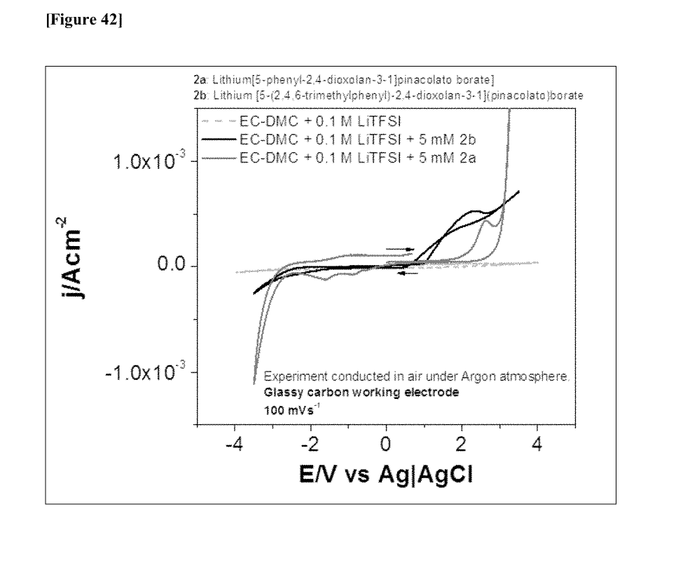

Results were shown in FIGS. 39-42.

### Example 4

### (Production of Cell)

Example 4 used a lithium symmetric cell having a structure of (SS|Li|electrolyte|GF/C|electrolyte|SS) mentioned in Example 3.

### (Charge-Discharge Conditions)

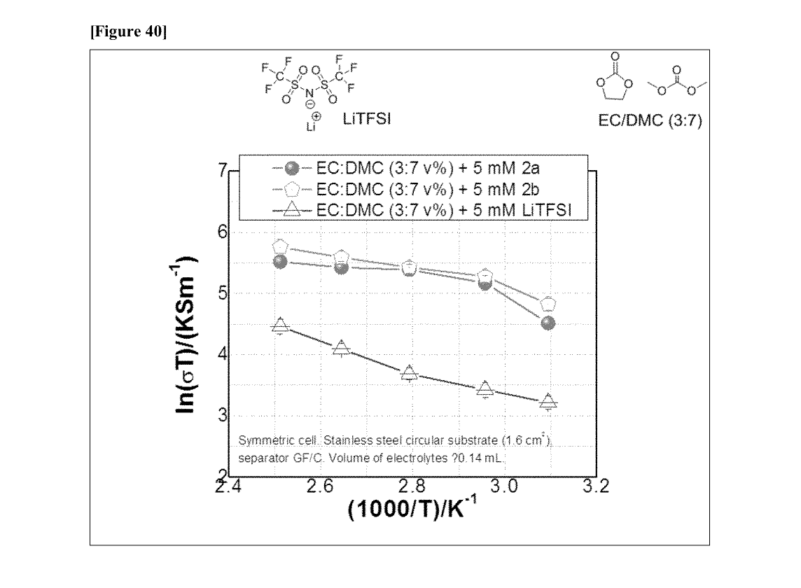

A terminal of the above cell was connected to a charge-discharge test apparatus (VMP3 potentiostat, manufactured by Bio-Logic Science Instruments). A program was prepared in which charge-discharge cycles are repeated as below. Specifically, in each of the charge-discharge cycles, charge (constant current charge) is carried out at an electric current density of 0.5 mA/cm² for 6 hours and then the charge is suspended for 0.5 hours, and discharge (constant current discharge) is carried out for 6 hours and then the discharge is suspended for 0.5 hours. In accordance with the program, the lithium symmetric cell used as a cell sample was charged and discharged at a room temperature. The cell sample was subjected to 9 cycles of a charge-discharge test. In the charge-discharge test, the following solutions were used as electrolyte solutions. Specifically, the solutions are (i) a solution serving as a basic electrolyte solution and obtained by dissolving 0.5 M LiTFSI in EC and DMC in a ratio of 3:7 (v %) (see FIG. 40) and (ii) a solution obtained by dissolving a 5 mM, 25 mM, or 50 mM compound 2b in (i) the solution serving as the basic electrolyte solution.

### (Result)

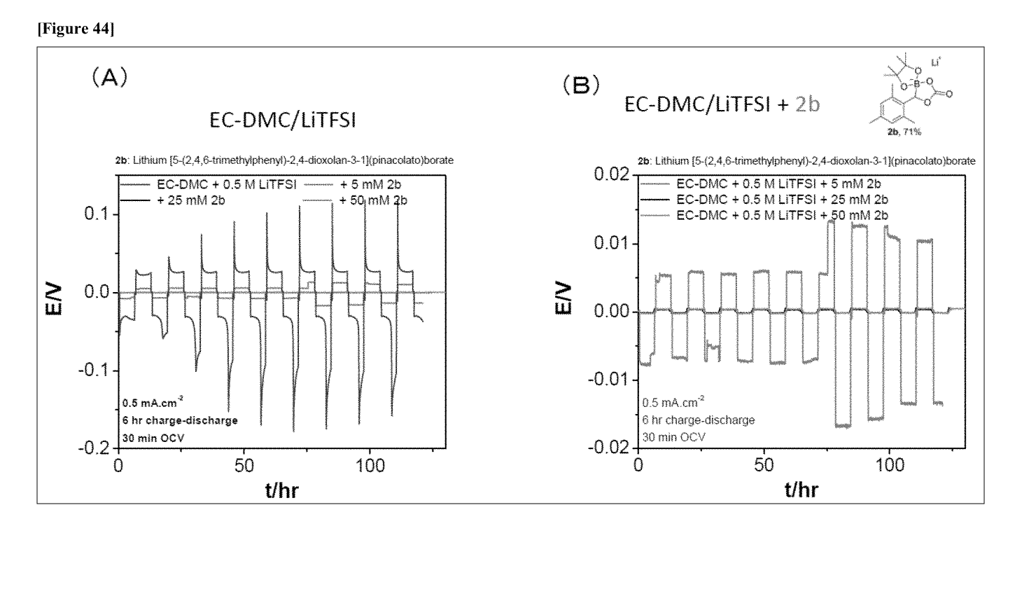

FIG. 44 shows a result of the above charge-discharge test. As shown in (A) of FIG. 44, it is understandable that a further decrease in overpotential is shown in each of examples, each obtained by dissolving the compound 2b in an electrolyte liquid (in (A) of FIG. 44, the example obtained by dissolving the 5 mM compound 2b in the electrolyte liquid is shown in red, the example obtained by dissolving the 25 mM compound 2b in the electrolyte liquid is shown in black, and the example obtained by dissolving the 50 mM compound 2b in the electrolyte liquid is shown in pink), than in a comparative example obtained by dissolving no compound 2b in the electrolyte liquid (in (A) of FIG. 44, the comparative example is shown in blue). (B) of FIG. 44 is an enlarged view of (A) of FIG. 44 (note, however, that (B) of FIG. 44 shows no result for the comparative example obtained by dissolving no compound 2b in the electrolyte liquid. It is understandable that though a further decrease in overpotential is shown in a case where the compound 2b is dissolved in the electrolyte liquid in a minimal amount (e.g., at a concentration of not more than 5 mM) than in a case where no compound 2b is dissolved in the electrolyte liquid, a dramatic decrease in overpotential is shown especially in a case where the compound 2b is dissolved in the electrolyte liquid at a concentration of more than 5 mM (see (B) of FIG. 44).

1. A method for producing a compound (i), comprising the step of:
reacting a compound (ii), a compound (iii), and carbon dioxide together in the presence of a copper catalyst and a lithium-based nucleophilic reagent,
the compound (ii) being represented by formula (1):
R3−C(R30)=X (1),
the compound (iii) being represented by formula (2):
(Z1)B−B(Z2) (2), and
the compound (i) being represented by formula (3): 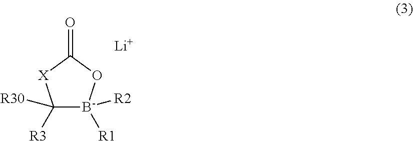
wherein X is O or NR4; Z1 and Z2 are each two hydroxyl groups, or are protecting groups for a boron atom (B) which protecting groups may be identical to or different from each other; R1 and R2 are each a group that is identical to Z1 or Z2, and may form a ring structure by binding to each other; R3 is any one selected from a hydrogen atom; an alkyl group; an alkenyl group; an alkynyl group; an aryl group; an aralkyl group; an alkylthio group; and an arylthio group each of which except the hydrogen atom may have a linear, branched, or cyclic structure; R30 is any one selected from a hydrogen atom; an alkyl group; an alkenyl group; an alkynyl group; an aryl group; an aralkyl group; an alkylthio group; and an arylthio group each of which except the hydrogen atom may have a linear, branched, or cyclic structure; and R4 is any one selected from an alkyl group; an alkenyl group; an alkynyl group; an aryl group; an aralkyl group; an alkylthio group; an arylthio group; an alkylsulfinyl group; an arylsulfinyl group; an alkylsulfonyl group; an arylsulfonyl group; an alkoxycarbonyl group; an aryloxycarbonyl group; a phosphoryl group; and a phosphonyl group each of which may have a linear, branched, or cyclic structure.

2. The method as set forth in claim 1, wherein the lithium-based nucleophilic reagent is a lithium alkoxide or a lithium amide.

3. The method as set forth in claim 1, wherein the copper catalyst is an NHC-copper catalyst.

4. The method as set forth in claim 2, wherein the copper catalyst is an NHC-copper catalyst.

5. The method as set forth in claim 1, wherein:
R3 is any one selected from a hydrogen atom; an alkyl group; an aryl group; and an aralkyl group each of which except the hydrogen atom may have a linear, branched, or cyclic structure; and
R30 is any one selected from a hydrogen atom; an alkyl group; an aryl group; and an aralkyl group each of which except the hydrogen atom may have a linear, branched, or cyclic structure.

6. The method as set forth in claim 1, wherein Z1 and Z2 each represent two —OR or two —NHR (where R is any one selected from linear or branched a C1-C20 alkyl group; a cycloalkyl group; and an aryl group), or Z1 which binds to B form a chemical structure being represented by the following formula (3-1) or (3-2) and Z2 which binds to B form a chemical structure being represented by the following formula (3-1) or (3-2):

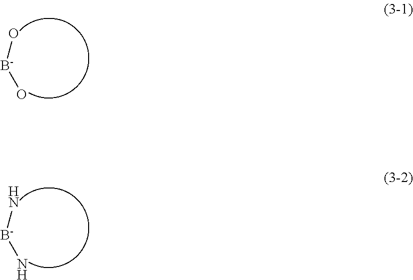

7. A compound represented by formula (3A): 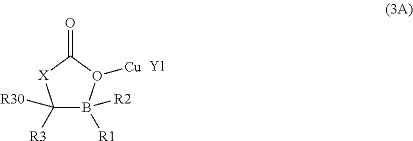
wherein Y1 is a ligand to a copper atom; X is O or NR4; R1 and R2 are each a hydroxyl group, or are protecting groups for a boron atom (B) which protecting groups may be identical to or different from each other, and may form a ring structure by binding to each other; R3 is any one selected from a hydrogen atom; an alkyl group; an alkenyl group; an alkynyl group; an aryl group; an aralkyl group; an alkylthio group; and an arylthio group each of which except the hydrogen atom may have a linear, branched, or cyclic structure; R30 is any one selected from a hydrogen atom; an alkyl group; an alkenyl group; an alkynyl group; an aryl group; an aralkyl group; an alkylthio group; and an arylthio group each of which except the hydrogen atom may have a linear, branched, or cyclic structure; and R4 is any one selected from an alkyl group; an alkenyl group; an alkynyl group; an aryl group; an aralkyl group; an alkylthio group;
an arylthio group; an alkylsulfinyl group; an arylsulfinyl group; an alkylsulfonyl group; an arylsulfonyl group; an alkoxycarbonyl group; an aryloxycarbonyl group; a phosphoryl group; and a phosphonyl group each of which may have a linear, branched, or cyclic structure.

8. A compound represented by formula (3): 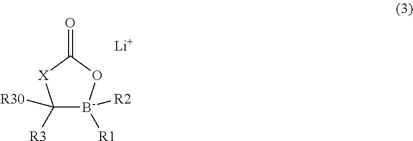
wherein X is O or NR4; R1 and R2 are each a hydroxyl group, or are protecting groups for a boron atom (B) which protecting groups may be identical to or different from each other, and may form a ring structure by binding to each other; R3 is any one selected from a hydrogen atom; an alkyl group; an alkenyl group; an alkynyl group; an aryl group; an aralkyl group; an alkylthio group; and an arylthio group each of which except the hydrogen atom may have a linear, branched, or cyclic structure; R30 is any one selected from a hydrogen atom; an alkyl group; an alkenyl group; an alkynyl group; an aryl group; an aralkyl group; an alkylthio group; and an arylthio group each of which except the hydrogen atom may have a linear, branched, or cyclic structure; and R4 is any one selected from an alkyl group; an alkenyl group; an alkynyl group; an aryl group; an aralkyl group; an alkylthio group; an arylthio group; an alkylsulfinyl group; an arylsulfinyl group; an alkylsulfonyl group; an arylsulfonyl group; an alkoxycarbonyl group; an aryloxycarbonyl group; a phosphoryl group; and a phosphonyl group each of which may have a linear, branched, or cyclic structure.

9. The compound as set forth in claim 8, wherein:
R3 is any one selected from a hydrogen atom; an alkyl group; an aryl group; and an aralkyl group each of which except the hydrogen atom may have a linear, branched, or cyclic structure; and
R30 is any one selected from a hydrogen atom; an alkyl group; an aryl group; and an aralkyl group each of which except the hydrogen atom may have a linear, branched, or cyclic structure.

10. The compound as set forth in claim 8, wherein R1 and R2 each represent —OR or —NHR (where R is any one selected from linear or branched a C1-C20 alkyl group; a cycloalkyl group; and an aryl group), or R1 and R2 each of which binds to B- form a chemical structure being represented by the following formula (3-1) or (3-2):

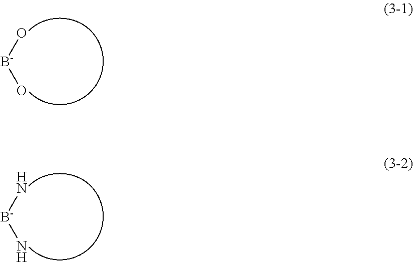

11. A lithium ion battery comprising, as an electrolyte, a compound recited in claim 8.
